(19) United States
(12) Patent Application Publication
(10) Pub. No.: US 2015/0149691 A1
(43) Pub. Date: May 28, 2015

(54) Directly Coupled Computing, Storage and Network Elements With Local Intelligence

(71) Applicant: Glenn Austin Baxter, Longmont, CO (US)

(72) Inventor: Glenn Austin Baxter, Longmont, CO (US)

(21) Appl. No.: 14/024,309

(22) Filed: Sep. 11, 2013

(51) Int. Cl. G06F 3/06

(52) U.S. Cl. CPC G06F 3/061; G06F 3/0688; G06F 3/0685; G06F 3/0661
USPC 711/103

(57) ABSTRACT

An apparatus that collapses computing, storage and networking elements into a tightly coupled, deeply vertically integrated highly scalable system that additionally provides augmented intelligence within each of the computing, storage and networking elements. A method to collapse computing, storage and networking elements while augmenting each of their intelligence. A system consisting of one or more scalable apparatus that collapse computing, storage and networking elements with augmented intelligence.

### FIELD OF THE INVENTION

Embodiments of the invention relate to the fields of computing, storage and networking, and in particular the interrelationship between each. Additionally the invention relates to data centers.

### BACKGROUND OF THE INVENTION

Present systems in data centers consist of discrete computing, storage and networking functions. Each of these functions is seen separately in both the hardware that is used to build each function, and in the software that runs on each function. Status quo system circa 2013 have limited purpose due to the way that the functions themselves have been crafted.

One major draw back of present systems is that they consume enormously more power than the embodiments of the invention contained herein. This power is a direct result of the separation of each of the elements of computing, storage and networking. In particular, since each of these elements is essentially contained within its own “box”, one can easily see the multiplicative consequences of added power supplies and components. Power is a large motivator in modern data centers because the data centers often consume AC wall power on the order of tens of megawatts. Thus, a ten percent reduction in power is considered of enormous value to the industry.

Power is not the only factor that data centers care about. Because the functions of computing, storage and networking in prior art are all rendered as effectively independent entities, a vast amount of three dimensional space is required to house these systems. This three dimensional size results in large purpose built buildings being crafted at substantially larger cost per square foot than conventional commercial construction.

Present data center systems also suffer enormous performance loss because of the aforementioned separation. To illuminate this point more fully, consider the fact that a typical hard disk in a typical data center storage server has a SAS interface, which in turn must be converted to Fiber Channel, and then from Fiber Channel to PCIe and then from PCIe to Ethernet and then from Ethernet to the CPU that operates the storage server. This are a large number of inefficiencies in the system. These represent a simple example of the limitations that are inherent in the way that present data centers operate.

Another distinguishing factor of prior art data center systems over the present invention is that they offer little to no purpose built intelligence. This means that any particular operation such as mining the storage system for some particular piece of information is effectively produced by offloading the intelligence to another agent. e.g. a CPU server must perform all of the gathering of data from the storage system, and then calculate the intended result before it is sent across the network system. This represents a huge misuse of the abilities of each system, as will be seen in the context of the present invention.

When one looks at the status quo, one can not help but realize there is enormous need within the industry for serious change in the way computing, storage and networking systems are built to craft data centers. The impressive reduction in system cost of the embodiments contained herein is itself sufficient motivation for change. However, the performance capabilities that the embodiments allow for provide substantial motivation. In the end, the present invention's new capabilities are what will provide a justification to move away from status quo systems to those of the present invention instead.

Given the deficiencies in current data center systems, what is needed are both apparatus, methods, and systems to address these deficiencies. The following description and claims will demonstrate vastly superior methods and apparatus to directly address these needs while simultaneously preparing for future changes within the data center.

### BRIEF SUMMARY OF THE INVENTION

The present disclosure demonstrates to those skilled in the art how to make a much better data center. In particular, an apparatus is disclosed which directly couples computing, storage and networking elements together wherein each of those elements has its own local and highly efficient intelligence.

One of the major deficiencies in present systems is the sheer number of times that the physical interface changes to get or put computed information. For example, when one reads a granted patent from the United States Patent and Trademark Office, information must be fetched across a network from a request on the viewers' computer. If one breaks down all that goes on in that seemingly simple process, one will find literally tens of interfaces that have to be crossed over. Each of these interfaces typically has a set of physical attributes associated with it, along with a set of software routines which must be run to effect the transfer. When considering the ‘cost’ of this example transaction, one has to look at how much power, time and physical volume that that transaction cost. Since almost no one pays for the entire part of those costs it is not at all obvious that these costs are indeed high. When one couples the fact that systems have pretty much all been made the same way since the dawn of computing, a form of confirmation bias is introduced into the thinking of those who design and manufacture such systems. The result is that the present system are designed in substantially the same way as systems from the 1960s.

The present invention described in detail below begins by re-imagining how a data center can be built using modern technology. This includes using the most modern possible CPUs, memory, storage, connectors, and other physical attributes of hardware. However, the embodiments also seek to alter how each of these elements are connected to each other in order to provide the most direct connection possible. The embodiments then further augment the resultant system with intelligence which is both localized to the element, and yet scalable and accessible as a vastly larger system. Lastly, the present invention intentionally re-imagines how software can be altered to take advantage of the direct connections and substantially altered data flow.

In general, the present invention can be thought of as a unification of three functions of the modern data center: Computing, Storage and Networking. The embodiments directly couple each of these three functions together with the minimum possible number of interfaces. This is then augmented by adding intelligence to each function to permit that function to operate with an expanded role. For example, adding local intelligence to the storage system permits data mining directly on the storage instead of across a network on some distant computing element. Because of the structure of the network function, and the fact that it is directly coupled, the resultant final system is highly scalable. In fact, it was a design intent to ensure that the system was scalable from single instances to many hundreds of thousands of instances.

A hugely distinguishing factor in the present invention is that the augmented intelligence contained within each function permits new classes of behavior to exist. Perhaps the best example of this in the present embodiment is the ability of the network to act in an intelligent way and become the “server” portion of the data center. To be clear, this ability does not exist in any present systems except through emulation. The reason is that the network does not have its own intelligence, it ‘borrows’ the intelligence from the computing function. One way to think about this is that all present operating systems and file systems use the compute element to actually operate. Yes, they speak to the storage and across the network, but in the end, it is the compute function that is doing the work. In the preferred embodiments, this workload is actually shifted to the network itself. This new capability offers functionality that has never existed before. In particular, the ability to craft a ‘self-aware’ network that knows how to ‘serve’ its other functions based upon the context of the requests it has received. Examples of this new ability include the ability to have the network itself schedule the amount of time a set of CPUs will operate on a particular problem, as well as contextually making switching the datasets needed in storage over to that appropriate CPU. Further, that the network itself is actually managing each individual storage element (e.g. NAND page) directly itself, and is aware of and manages the idiosyncrasies of those storage elements. These kinds of capabilities will alter the definition of both operating systems and file systems as they are presently known, and will offer new synthetic capabilities that make data mining, sensor fusion and other similar kinds of problems vastly simpler to solve.

In brief summary, the present invention can be thought of as directly connecting newly intelligent agents of augmented computing, augmented storage and augmented networking together in ways that allow for direct scalability of the resulting platform while simultaneously vastly reducing power, cost, three dimensional volume, and vastly increasing the effective performance of the system. A more detailed understanding of the specific elements of the invention can be found below, and more specifically alliterated by the attached claims.

### BRIEF DESCRIPTION OF THE DRAWINGS

The accompanying drawings are included to provide further understanding of the invention, and are incorporated in and constitute a part of this specification. The drawings illustrate embodiments of the invention, and together with the description, serve to explain the principles of the invention. In the drawings:

FIG. 1 shows a prior art simplified block diagram of a data center.

FIG. 2 shows a prior art block diagram of a high performance computer.

FIG. 3 shows a simplified block diagram of one embodiment of the invention.

FIG. 4 shows a detailed block diagram of a NAND Complex.

FIG. 5 shows a detailed block diagram of a CPU Complex.

FIG. 6 shows an example Ethernet connection between NAND and CPU Complexes.

FIG. 7 shows an example PCIe connection between NAND and CPU Complexes.

FIG. 8 shows an example Ethernet switch connections for control and connectors.

FIG. 9 shows an example Ethernet switch connections to CPU Complexes.

FIG. 10 shows an example Ethernet switch connections to NAND Complexes.

FIG. 11 shows a partial example of a Clos switch for PCIe.

FIG. 12 shows an example block diagram of the motherboard of a 2U chassis in accordance with an embodiment of the present invention.

FIG. 13 shows an example 2D layout of a 2U chassis in accordance with an embodiment of the present invention.

FIG. 14 shows an example of a number of chassis collected into an industry standard rack in accordance with an embodiment of the present invention.

### DETAILED DESCRIPTION OF INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

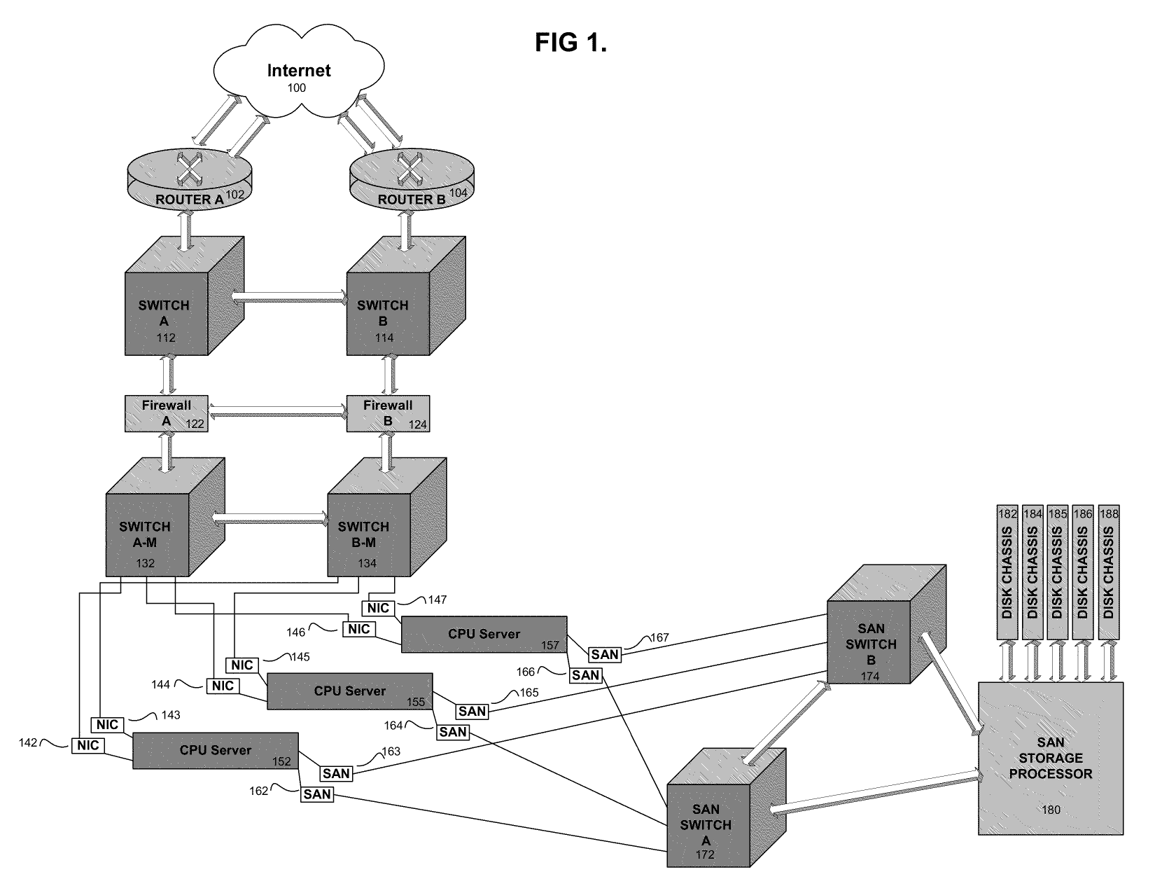

Prior art data centers are built from elements that collectively can be thought of as operating as a computer. Typical elements, as exampled in FIG. 1. consist of CPU servers 152, 155, 157; SAN Storage Processor 180 and a Network consisting of Routers 102,104, Switches 112, 114, 132, 134, 172, 174; Firewalls 122, 124; NICs 142-147; SAN ports 162-167; and Disk chassis 182-188. Note that this example is illustrative only to demonstrate the elements, not a specific connection pattern or data center architecture which is typically application dependent. There are numerous means of interconnecting these elements based on a wide variety of industry standards. Much innovation has been done within each of the elements to work toward some particular goal such as energy efficiency or performance. However, the plethora of standards has made it very difficult to craft program models for these large computers that work with reasonable efficiency. One status quo solution to this problem is to make each element “standard” and to replicate the element over and over. This has great advantage over mixed element data centers. However, unless the data center operator is an expert programmer, they can not readily take advantage of the near homogeneity of the architecture.

Replication of same elements over and over again does not force homogeneity of the system. Even if there are expert programmers available to program the supposedly homogenous system, the work they do is towards an application specific purpose, which relegates the system to a now special purpose. Though the hardware might be more general purpose, the end effect is to craft an application specific purpose. In a data center such as one that exclusively runs say Netflix, Inc. movie streaming, this is probably a good thing. But in a data center that wishes to be many different kinds of applications and process many different kinds of data, then a purpose built system is not very effective. Note that the homogeneity is not the cause of this lack of effectiveness—the difficult to use programming model is.

Prior art data centers, such as those illustrated by FIG. 1 have other severe limitations over the preferred embodiment illustrated herein. Specifically, even if the prior art system is fully homogenous, it is deeply complicated. Looking alone at the network of routers, switches, firewalls, more switches, and still more switches, the complexity is obvious. What is not so obvious is why it is needed, nor the effect that the complexity has.

Consider for example that the data center of FIG. 1 houses a picture that someone wishes to get from the data center across the world wide web to their local computer. Once the request to obtain the photo arrives from the local computer across the world wide web from Internet 100, it must be properly routed to the agent that will obtain the photo from the appropriate disk chassis 182-188. Watch what happens: Request arrives from Internet 100, and is sent to Router A 102 which in turn sends a request to Switch A 112 where a decision might be made to send to Switch B 114 because Switch A 112 is very busy and can not presently handle the request. This is something known in the industry as load sharing, and while uncommon in many networks, is gaining popularity in the data center to help get ingress and egress data bandwidth raised. Switch B 114 then passes on the request to Firewall B 124 which tests that the request is OK to send downstream. In turn the request is forwarded to Switch B-M 134 which then determines to send it to NIC 145 on CPU Server 155. At some point, CPU Server 155 analyzes the request, validates it, authenticates it, and eventually has to find out where the photo in question resides. This process is well known in the art and is thus not described here. Once the specific file is known, the CPU Server sends a different kind of request through SAN port 165 to SAN Switch B 174. SAN Switch B 174 in turn forwards the request to SAN Storage Processor 180 who determines specifically which Disk Chassis(s) the photo is on. Since most data centers can not tolerate data loss, the SAN Storage Processor 180 will often treat its disk chassis 182-188 as a RAID system, well known in the art. RAID typically forces a large data set like a photograph to have its data spread across the Disk Chassis(s) so that a loss of a disk within the system will not lose data. Thus the SAN Storage Processor must determine where all of the parts of the photo are, and to initiate requests for each part of the data so that it can be sent back to the originating requestor. This involves numerous transactions between the SAN Storage Processor 180 and the Disk Chassis 182-188. The data that is gathered is sent back through SAN Switch A 172 to SAN port 164 to CPU Server 155. Typically, CPU Server 155 will gather all of the data for the photo before it sends it back up to Internet 100. This is done to help create larger transactions across the network fabric and thus use that network fabric more efficiently. Once the data has been fully gathered across the storage network from disk chassis 182-188, and has been properly processed and is now ready to go, CPU Server 155 sends the data back up through NIC 146 to Switch A-M 132 back through Firewall A 122, Switch A 112 and to Internet 100 where it is routed back to the local computer.

The above illustrative example is actually greatly simplified over real life in a data center, but demonstrates a particular degree of complexity. What is not obvious to many, including those skilled in the art, is the number of times that the requests and data itself in that very simple transaction are reformatted, or changed in some substantial way. For example, each time an interface is crossed, the information is temporarily stored. This means that information is also stalled, and while waiting is burning DC power. When an interface is changed, as when we transition from NIC 145 to CPU Server 155, the information is changed from Ethernet to PCIe, for example. This transition requires a reformatting of the information so that it fits the new standard. Typically this is done via encapsulation. Encapsulation can be thought of as the Russian dolls that fit one doll inside another. Each layer of encapsulation adds a ‘wrapper’ doll to the information. This means a number of things. First, the data must be stored while it is being encapsulated; second, a processor of some form (hardware or hardware and software) must be adding the new information which forms that particular layer of the encapsulation; third an agent elsewhere will now be responsible for unwrapping, or unencapsulating the information at each cross of boundary. When one counts up the number of times that this process happens on just the simple transactions, it is truly staggering. More importantly, it is incredibly wasteful of processing, bandwidth, hardware costs, latency, and DC power.

The modern data center is not a creation. It is an evolution. In so doing, the modern data center has adopted numerous well known standards to protect information security, authentication, and information integrity. The above typical example is so complex expressly because these systems have evolved from standards which themselves have evolved over a number of years. In many ways, this is much like a duct tape boat that had to keep adding new capabilities as new challenges are found. More and more duct tape is applied to keep the boat functional for its intended purpose. Rarely does one re-evaluate the design of the boat to see if it could be done more efficiently.

In point of fact, the supposedly modern data center where the Power Use Efficiency (PUE) factor is “best”, such as the efforts of the Open Compute consortium, is a very poor measure of efficiency that actually matters because these systems fail to regard the underlying complexity as simplify-able. This is actually an exceptionally poor ‘redesign’ because it did not deal with why the large amounts of power were necessary in the first place. Instead, the PUE effort focuses on a financially tangible consideration of wasted power in the cooling systems. Such systems maintain the inherent software, hardware and system complexity of multiple different interfaces all while changing the topology of the system.

Alteration of a system's topology is often very useful for specific sets of problems. However, if one does not also consider the inherent complexity within the rest of the system, vast swaths of inefficiency are left behind, and often forgotten because it is felt it takes too much work to address those inherent complexities. This is particularly the case when those skilled in the art design modern data center components. They focus instead on reuse of existing standards, rarely asking if they had the opportunity to design from scratch if they would build the same standards and interfaces. The system demonstrated herein addresses both the homogeneity, topology, and complexity questions simultaneously to create a new apparatus, methods and systems that are substantially more cost effective, substantially faster, substantially more capable and substantially smaller in physical volume and AC wall power. The present invention also offers new capabilities that present systems lack, and which will provide benefit in ways that are unforeseeable.

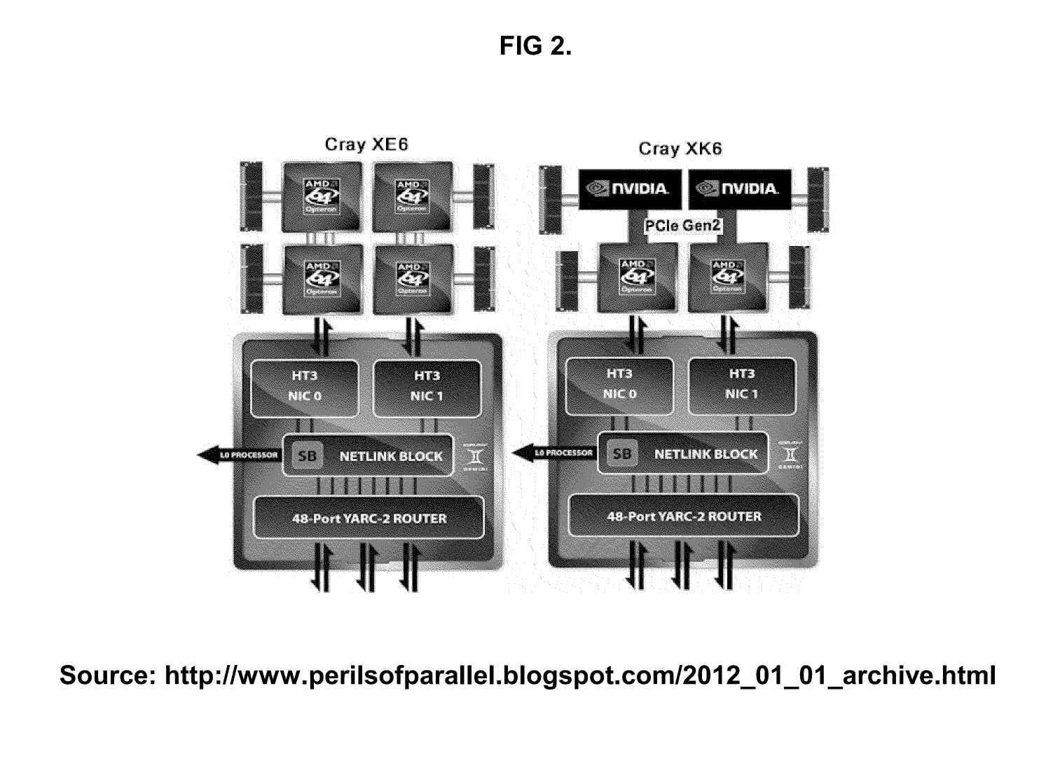

FIG. 2. shows an example internal block diagram of a modern High Performance Computer (HPC), also known as a super computer. This particular example is showing an internal block diagram of part of the new HPC at Oak Ridge National Laboratory (ORNL) named Titan. Titan is an approximately 20 petaflop HPC consisting of a very large number of nodes built as shown in FIG. 2. This HPC is built by Cray Research as the XT7 super computer. It is one of the world's fastest and most power efficient HPCs. In the ORNL Titan computer, the HPC itself is housed in a 21×6 array of approximately six foot tall racks, along with another 6×6 array of other cabinets with associated equipment. This works out to a floor space of somewhere around 162 cabinets. One very important aspect of the HPC is that it's storage elements are separate from this set of cabinets. This is important because typically HPCs run for about an hour, and then synchronously stop to dump the presently calculated data set to a set of hard drives. This dumping of data is used both to restart a calculation if something goes wrong as well as to analyze the quality of the prior calculation. Often, the analysis is done by another HPC looking off line at the data. For example if running a numerical simulation of the climate over time, analysis of the data processed so far may show a divergence from the model in the HPC, and the operator may wish to alter parameters, or the model itself. This interaction is often very important for specific classes of HPC users.

Typical HPCs are built differently from data centers. Yet they have similar kinds of functional behavior. They have a more refined and purpose built network to aid in the cooperative sharing of data between computing elements. In general, HPCs are large computers built from similar elements of computing, storage and networking. The major difference here is the way that they intend to process information. In an HPC, as much information as possible is kept in the main memory of the HPC, and the storage system is generally only used to house copies of the main memory at specific points in time, known as check points.

In its heart, an HPC is a purpose built computer that optimizes for the specific and very unique characteristics that work well for a specific class of problem. While this architecture is very homogenous, and highly scalable, it does not posses augmented intelligences. Indeed, typical HPCs are bare bones CPU cores with main memory, and a fabric switch to interprocess communicate between the nodes. But HPCs would make terrible data center computers because their purposes are so vastly different. This prior art is important to note because it demonstrates the principles of simplification of the system in direct contrast to that of the data center.

Beyond that, one skilled in the art will understand that what truly makes the HPC function well is the way the network is deeply populated with very high bandwidth connections. This is in direct contrast to data centers which use very sparse interconnection. Many errantly believe that these interconnections are not needed. This belief is another form of confirmation bias spoken of earlier. Distilled, when the performance of the system is below some particular threshold, the reason to have high bandwidth deeply populated connections is not obvious. Once past that threshold, it becomes far more understandable why high bandwidth deeply populated connections are important. However, in present data centers, the massive complexity of the system inherently results in a lack of need for these kinds of interconnections expressly because the complexity limits the performance and utility of these connections. A slightly exaggerated analogy: perhaps one could think of this like the time before we thought it possible to break the sound barrier. Because we believed it was impossible to break, for the longest time, no one really tried to actually break it. Only when one started to think beyond that barrier was the technology developed to show the usefulness of breaking the sound barrier. In the case of the high bandwidth deeply populated network, so far only HPCs have really had the need, and thus develop and deploy the technology. The prior art data center actively dismisses this as a necessity for its own use.

Turning away from prior art descriptions toward the present invention, the remaining figures will help to illustrate various aspects of the present invention.

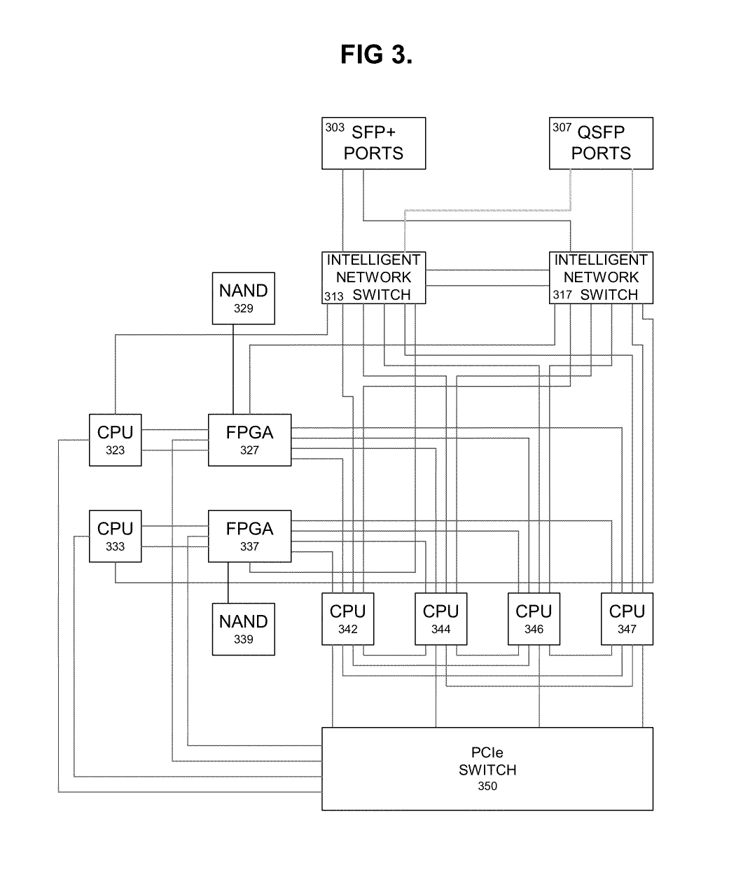

FIG. 3. shows a highly generalized block diagram in accordance with one embodiment of the invention. CPUs 342, 344, 346, 347 are interconnected to intelligent network switches 313, 317; Field Programmable Gate Arrays (FPGAs) 327, 337; and PCIe switch 350. FPGA 327 also connects to CPU 323 and NAND 329. Similarly FPGA 337 also connects to CPU 333 and NAND 339. The provision of connections between the CPUs 342-347 and intelligent network switches 313, 317 are connected via Ethernet, and more specifically by 10 Gigabit Ethernet (10 GE). Similarly, the FPGAs 327, 337 and CPUs 323, 333 are also interconnected to the intelligent network switches 313, 317. PCIe switch 350 interconnects the CPUs 323,333; FPGAs 327,337; and CPUs 342-347. Intelligent switches 313, 317 also connect to externally facing SFP+ Ports 303 and QSFP Ports 307.

The present invention is broadly illustrated in FIG. 3 in deep contrast to prior art systems shown in FIG. 1 and FIG. 2. FIG. 3 represents functionality which is logically equivalent to that of the shown prior art. This logical functionality is obtained through vastly simpler and different means.

Beginning at SFP+ ports 303, a 10 GE ingress/egress means directly from the internet is made available. Similarly, QSFP ports 307 offer a 40 Gigabit Ethernet (40 GE) set of ports that provide 40 GE ingress/egress directly from the internet. The 10 GE or 40 GE ports are fed directly to the intelligent network switches 313, 317 which handle all of the work of the entire network shown in FIG. 1. Intelligent Network Switches 313, 317 are designed to handle all functions related to internet traffic such as authentication, firewalling, data transport security, data transport integrity, control and data plane traffic, information routing/switching and other similar features that are built in FIG. 1 by routers 102, 104; switches 112, 114, 132, 134, 172, 174; and, by firewalls 122, 124. It can be seen by this functional comparison alone that the present invention is vastly simpler and vastly easier to implement compared to prior art.

Requests for serving of content from the internet thus enter the preferred embodiment of the invention at one or more SFP+ ports 303 and/or QSFP ports 307. These requests then transit the switches 313, 317 and are sent to CPUs 342-347 to be processed. In one embodiment a single CPU 342-347 receives the request. In another embodiment two or more CPU 342-347 receive the request. In still another embodiment all CPU 342-347 receive the request. The latter two embodiments can be used by the system to provide for load sharing. Importantly, CPUs 342-347 are logically equivalent to CPU servers 152, 155, 157 insofar as information processing is concerned.

CPU 323 coupled to FPGA 327 and CPU 333 coupled to FPGA 337 along with FPGA 327 coupled to NAND 329 and FPGA 337 coupled to NAND 339 together represent an intelligent permanent storage system for the present invention. Specifically, in one embodiment CPUs 323/333 obtain requests from other agents, either directly from the 10 GE or 40 GE sources, e.g. ports 303 or 307, or from the CPUs 342-347 as appropriate via either of PCIe switch 350 and/or intelligent network switches 313/317. These requests result in data being read or written, or control information presented to effect the same logical equivalent to SAN storage processor 180 and disk chassis 182-188 shown in FIG. 1.

In the preferred embodiment data plane information is sent through the internal 10 GE network shown in FIG. 3, while Inter Process Communication (IPC) or control plane information is communicated via the PCIe network. The PCIe network shown in FIG. 3. in the preferred embodiment is actually built as a Clos or fat-tree switch. Clos switches are well known in the art, but are not normally applied to a PCIe switch network. This application is new and exceptionally useful because it permits non-blocking full bandwidth communication between any agent using the switch, assuming that the requested agent is not already busy in another transaction.

Prior art systems are built with a plethora of interfaces. These interfaces are most often not directly compatible with one another and thus encapsulation techniques are used to allow the information to transit each different kind of interface. The present invention is vastly simpler than prior art expressly because its conceptualization was from the basis of minimizing interfaces. Moreover, prior art nearly always uses international standards such as Ethernet, PCIe, SAS, SATA, Infiniband, and Fiber Channel. In fact, the prior art systems use these differing standards as a pre-requisite because various manufacturers need to allow their small piece of equipment such as a CPU server, a network switch or a SAN server to be able to interoperate with other equipment. One of the main advantages of the preferred embodiment is the elimination of as many types of interfaces, and as many transitions across the remaining interfaces as humanly possible. The end result is a substantially power, volume and cost efficient system that replaces large swaths of data center equipment in a single small box. This is not about miniaturization. This is directly and intentionally about elimination of complexity.

The origination of the invention was as a result of a thought experiment about how to get rid of the sources of inefficiency within the data center. By analyzing the way data centers are built from the ground up, and from the top down, it was possible to discern a means to collapse large parts of the data center through the elimination of effectively redundant elements. However, the actual means for elimination, and the actual elements that were removed are not at all obvious. What became clear was that if it were possible to build a fully populated network, and it were possible to contain a large amount of storage, and if it were possible to embed power efficient CPUs all into the same platform while simultaneously allowing for sufficient ingress/egress of information and while allowing for expanding between boxes using a means that could scale to large data center sizes, and if it were possible to add intelligence into each of the three basic elements of computing, storage and network, that then it would be possible to collapse all of the present data center infrastructure into a single, scalable, replicable platform. It also became clear that it was highly useful to add IPC means between elements to allow for future kinds of software which radically alter how data centers are built today. In some embodiments, the addition of the PCIe switch 350 are not required, but those embodiments will suffer performance and power loss against the preferred embodiments that have such once these future kinds of software are operating upon the invention.

Most engineers define systems with a set of criteria based upon a customer's need. This results in many systems being highly specialized. It is often true that such systems have limited use beyond their originally intended purpose. One artifact of this is that such systems do not conceive of a future beyond which present knowledge might substantially change. The present invention has a number of intentional design elements both topologically as well as functionally that are designed to be ready for an unknown future.

Like many present day servers, the present invention is upgradeable. It is upgradeable in a few different ways from prior art. First, it utilizes a mother board and card set structure rather than a back plane, which allows cards to be altered for differing types of functionality over time. Second, it has a set of cards that are storage elements, a set of cards which are compute elements and a set of cards which are network elements with a relatively passive mother board. Third, the present invention specifically adds valuable changeable intelligences to the cards. Most data center systems involve software intelligence, and a fixed hardware intelligence. The present invention allows for both the software changes, but more importantly dynamically changeable hardware in the form of FPGAs. The FPGAs are capable of doing many different kinds of tasks because the hardware is based on bits stored in a changeable RAM. In fact, the present invention is capable of “sharing” it's FPGA logic over time and enables the switching out of hardware algorithms while the system is running. One example use of this is video filters being applied to incoming data wherein the FPGA houses one kind of filter for one moment, and then shifts to a different kind of filter the next. Part of the reason for the connection between CPU 323 to FPGA 327 and CPU 333 to FPGA 337 is expressly to allow a kind of ‘co processing’ augmentation between the CPUs and the FPGAs.

Another vital aspect of the preferred embodiment is the intelligences referred to above. Most data center systems tend to consider the CPU server as the “intelligence” of the system. In collective, the entire communications network of FIG. 1 demonstrates a primitive intelligence. Similarly, there is a primitive intelligence in the storage subsystem of many data centers. What is missing from these systems that the present preferred embodiment offers is large scale intelligence in each of the three primary elements of computing, storage and networking. The computing element is pretty intelligent in most prior art systems whereas the other two have little to no advantageous intelligence. In contrast, the preferred embodiments intentionally add hardware and software intelligence to each element. The CPUs 342-347 for example actually house hardware and software which unload difficult and time consuming calculations for specified classes of interface such as PCIe and 10 GE. They also add packet processing hardware to enable the core CPU to focus on processing of information instead of processing of transitions across interfaces. Similarly, by using FPGAs 327/337 to drive NAND 329/339 respectively, data can be mined directly from the NAND 329/339 by FPGAs 327/337, without CPU 342-347 being involved in the process. Should the function in FPGAs 327, 337 require more sophisticated algorithms, then CPUs 323, 333 can be used to augment the then-present hardware intelligence in the FPGAs 327, 337. It is an exceptionally significant departure from prior art to embed this kind and level of intelligence right at the storage element. In the same way that the CPU and storage elements have added intelligence, so too does the main data network. The 10 GE infrastructure which is used connects to intelligent network switches 313-317. Each of these switches is capable of running stand-alone without any external intervention to effect the communication of information. However, each switch also has strong processing capabilities such as deep packet inspection while the data is being switched. Further, the intelligent ethernet switch 313, 317 can be augmented by their own local CPU that can set up and tear down entire fabrics in real time.

The synthesis of the computing, storage and networking into a single cohesive, intelligent and scalable platform can be better understood through a deeper dive into a preferred embodiment. This synthesis is what permits the at scale advantage of the invention over prior art systems.

It should be noted that FIG. 3 is a conceptual diagram of the invention and that those skilled in the art will better understand preferred embodiments through the remainder of the figures.

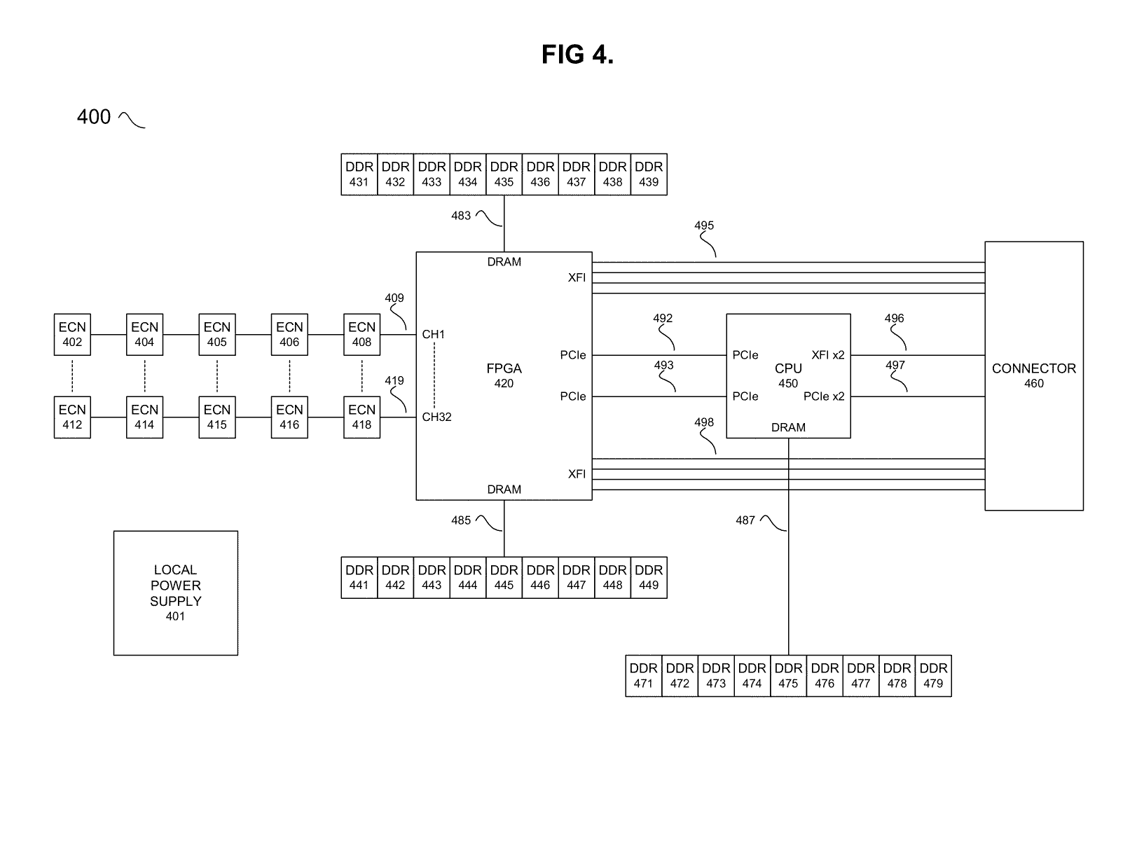

FIG. 4 is a detailed block diagram of a preferred embodiment of one aspect of the present invention. This block diagram is of the NAND complex 400, referenced in later figures. Connector 460 allows a set of XFI standard and PCIe standard connections to CPU 450, and a set of XFI connections to FPGA 420. Note that XFI is a 10.125 Gbit/sec standard implementation of 10 GE. CPU 450 also connects to DDR 471-479 to implement a 72-bit DDR3 SDRAM. DDR 471-479 are the main memory store for CPU 450. Not shown is a ROM connection to CPU 450 to store program information and boot code. CPU 450 also connects to FPGA 420 through PCIe connections 492, 493. This allows the CPU to request work from FPGA 420, and to receive data when appropriate. Note that generally the FPGA will send data back to the requestor via XFI 495, 498. FPGA 420 is connected to a set of 32 channels of solid state storage, ECN 402-408 in channel 1 and ECN 412-418 in channel 32. The FPGA 420 logic implements at minimum the amount of logic required to drive the solid state interfaces 409/419; the PCIe interfaces to CPU 450 and in some embodiments to connector 460; and the 10 GE interfaces XFI 495/498 from connector 460. FPGA 420 also connects to DDR 431-439 via interface 483 and to DDR 441-449 via interface 485. FPGA 420 in addition to the prior listed duties also controls DDRs 431-449 to provide for temporary storage of control plane information as well as cacheing of data. In one embodiment, FPGA 420 controls 10 TB of NAND flash storage devices and 64 GB of DDR3 SDRAM. Local power supply 401 allows for a larger single DC voltage to be supplied to NAND complex 400 and split into the appropriate voltages and currents the NAND complex 400 requires.

Functionally, CPU 450 receives requests for information from the network via connector 460 and XFI ports 496/497. CPU 450 can be best thought of as the SAN Storage Processor 180 of FIG. 1 because it does very similar kinds of functions. In the preferred embodiment of the present invention, CPU 450 is responsible to accept a request for information from elsewhere and identify where in all of its data the particular piece(s) of information reside, and then to set up requests in FPGA 420 to gather the data and send it back to the requestor via XFI 495 or XFI 498. Those skilled in the art will recognize that there is more than one way to receive the requests and to transmit the information back including multiple XFI lines, and/or via PCIe either directly, or via CPU 450 should some information filtering be desired. Generally speaking CPU 450 is a traffic cop and is looking for how to request information from the storage array in the most efficient manner possible.

As mentioned in FIG. 3 description, FPGA 420 (which is one of FPGA 327, 337), is added to allow for changeable intelligence that is directly coupled to the storage element. Consider a case where FPGA 420 knows where files are located within the storage element consisting of ECN 402 to ECN 418; and, wherein has been programmed to do a very dumb search for a particular word and then to report back the names of the files that contain those words. Doing this kind of action in a FIG. 1 prior art system requires exceptionally complex, and large numbers of transactions between the CPU servers 152-157 and the SAN storage processor 180 as well as disk chassis 182-188. In contrast all of that activity is contained purely within FPGA 420 and ECN 402-418. This example helps illustrate a new kind of rapid data mining that the preferred embodiment of the present invention brings. Whereas data mining is becoming of increasing complexity and importance, the ability to contain the entire set of transactions required to find a piece of information within the storage system is of enormous advantage. FPGA 420 can be reprogrammed over and over again and this in turn permits a large number of possible algorithmic solutions to finding pieces of information within the data set. Since the programming is dynamic, data could be gathered in DRAM and kept there while FPGA 420 is reprogrammed. The trade off is between the speed of gathering the data again versus the speed of reprogramming some or all of FPGA 420.

If this were a typical hard disk based prior art data center, the seek times of a hard drive alone contained within disk chassis 182-188 would far outweigh the partial reconfiguration time of FPGA 420, let alone the time it would take to gather or process the data through SAN storage processor 180, SAN switches 172, 174, SAN interface 162-167 and finally at one of CPU servers 152-157. It can thus be seen that there are very large performance advantages of having intelligence inside the storage node rather than the way prior art systems are crafted.

Further, because the vast majority of prior art systems utilize hard disk technology instead of solid state storage technology, there are even larger gains of performance in the preferred embodiment of the present invention. There are some prior art systems that are starting to replace the hard disk drives with solid state drives (SSD). These systems rely upon standardized interfaces that the storage industry have established such as SAS, SATA and occasionally PCIe. The difficulty with all of these prior art systems is that the software stack which goes with these interfaces requires a relatively large overheard to obtain information. None of the interfaces were designed with the characteristics of solid state storage in mind; rather, they were all designed for hard drives and their unique and peculiar characteristics. There is an enormous amount of waste in software, required processing and latency across these systems that is not present in the preferred embodiment. The reason this is true is because of an intentional movement away from the standard interface and standard protocols to a minimalist protocol across the interface. Thus the preferred embodiment of the present invention has manifold improvement over prior art storage systems because it directly attaches the solid state elements to processing elements; provides a vastly simpler interface to accomplish work; has very large amounts of local DRAM storage for cacheing information; can store the entire ‘table of contents’ of information inside its local DRAM storage; because it can know where the information is located within the storage it is capable of processing data without intervention from external sources; provides a dynamically reconfigurable FPGA that can process data at hardware speeds; allows for autonomous storage operations without the intervention of external CPUs (e.g. CPU server 152-157.

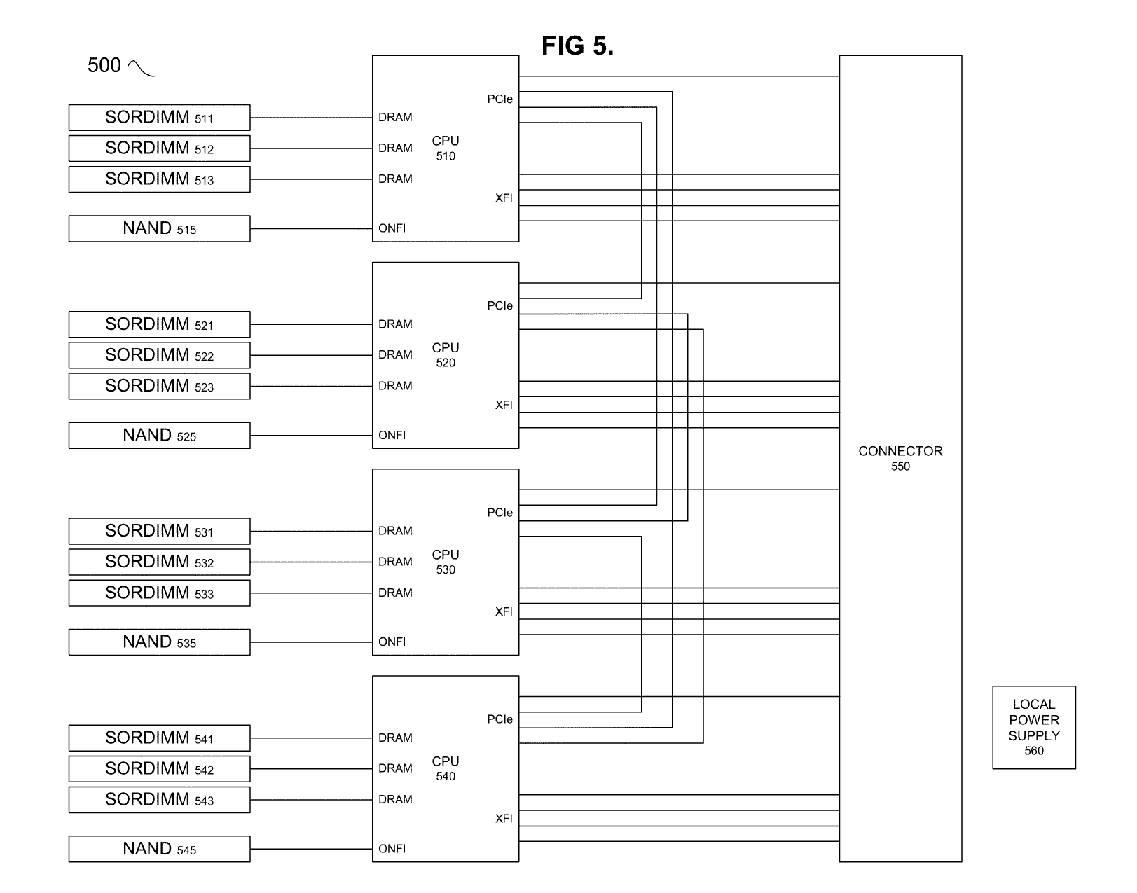

FIG. 5 illustrates CPU complex 500 in accordance with the preferred embodiment of another aspect of the present invention. CPU complex 500 consists of four nearly identical structures.

There are four separate CPUs each of which is connected to DRAM and NAND storage elements. For example, CPU 510 connects to three separate 72-bit DRAM SORDIMMs 511-513 via a DDR3 DRAM interface, and to NAND 515 via an ONFI interface. Similarly CPU 520 connects to three separate 72-bit DRAM SORDIMMs 521-523 via a DDR3 DRAM interface, and to NAND 525 via an ONFI interface; CPU 530 connects to three separate 72-bit DRAM SORDIMMs 531-533 via a DDR3 DRAM interface, and to NAND 535 via an ONFI interface; and CPU 540 connects to three separate 72-bit DRAM SORDIMMs 541-543 via a DDR3 DRAM interface, and to NAND 545 via an ONFI interface. CPUs 510, 520, 530 and 540 each connect to connector 550 with a set of four XFI interfaces to provide 10 GE connectivity and one PCIe interface to provide PCIe connectivity. CPUs 510 also directly connects with a single interface, which could be either PCIe or XFI, or even a private interface, to each of the other CPUs 520, 530, and 540. In this way there is a non-switched high speed information conduction path between the CPUs of CPU complex 500. This is very useful for sharing of load or for coordinating messaging, or for coordinating information processing in HPC use. The NAND 515, 525, 535, 545 is used to provide boot code, security codes and store any required local static data that the CPUs 510, 520, 530, 540 might need. In the preferred embodiment CPUs 510, 520, 530 and 540 are large multi-core complexes that also provide the offloading of work to other internal hardware such a frame managers, TCP/IP Offload Engines (TOEs), search engines, security processors, and authentication units. The added intelligence of CPUs 510, 520, 530 and 540 provides enormous effective performance over prior art data center CPU servers 152-157. CPU complex 500 in the preferred embodiment also contains a local power supply 560 which takes in a single DC power supply and crafts the required power to the components of CPU complex 500.

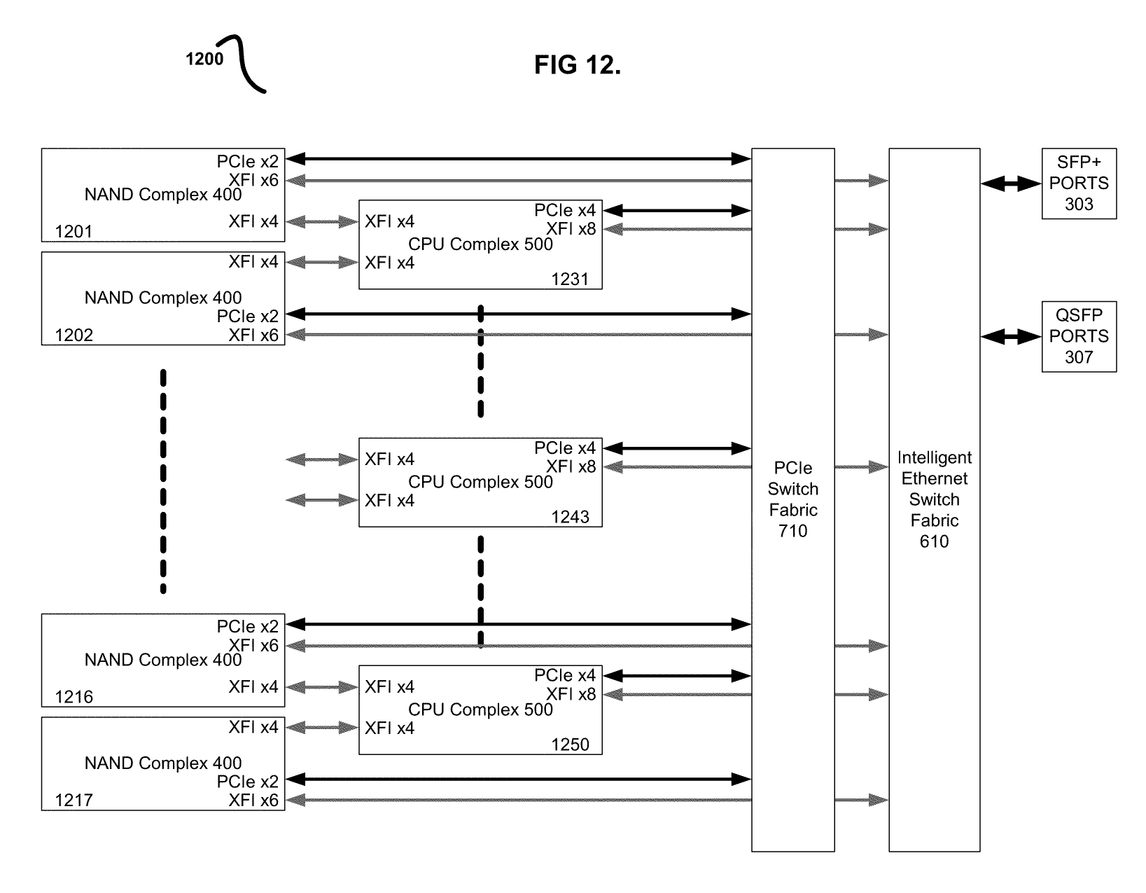

The reason that NAND complex 400 and CPU complex 500 exist is so that a modular system can be created which allows for these elements to change over time. For example, as larger NAND devices become available, NAND complex 400 can change to accommodate those. If a better long term storage technology comes along, the NAND can be replaced with something else, for example Resistive RAM (RRAM). Thus NAND is used herein to mean an appropriate memory storage technology for non-volatile storage of data. Similarly, if better CPUs become available that are more power efficient, or have greater processing power, then CPU complex 500 may be changed to accommodate those. In point of fact, as FIG. 12 will show, the interface between all of these complexes and the networks are simply wire that allows for high speed serial communications so even the type of communication could be changed since the motherboard is passive. All of this is an intentional recognition within the preferred embodiment that technology changes over time and that a well designed system accommodates that change to provide long life to users.

In the preferred embodiment according to the present invention, a multiplicity of NAND complex 400 and CPU complex 500 can be installed into a chassis. The number of these is limited by the physical volume that the chassis allows for. For example, an industry standard 2U chassis might house 16 NAND complex 400 cards and 20 CPU complex 500 cards along with other required elements to craft a final system. What relatively quickly becomes obvious is that each of these cards needs a means to be powered, and a means to communicate with one another.

An important reason for separating NAND Complex 400 and CPU Complex 500, as well as Intelligent ethernet switch fabric 610 and PCIe switch fabric 710 is so that they can be changed over time within a chassis. For example, while FIG. 5. shows an example of CPUs 510-540, those skilled in the art will recognize that there are many means of processing information such as Graphics Processing Units (GPUs) and even Field Programmable Gate Arrays (FPGAs). It is an express intention of the invention to allow for differing types of computing, and indeed differing types of storage within CPU Complex 500 and NAND Complex 400 respectively. There are implementations for specific problem sets such as those found in scientific computing which might have a stronger power or performance advantage by replacing FIG. 5's CPU complex 500 using one or more FPGAs either augmenting, or in place of CPUs 510-540.

The best mode of FIG. 5 is where differing kinds of CPU Complex 500 cards are built, in accordance with one embodiment of the invention, to allow for multiple types, and even mixed types of CPU Complex 500 cards within the same system or same chassis. This permits the system to adapt over time, or to be particularly configured as appropriate to a specific problem set. Those of ordinary skill in the art will understand how FPGAs, and/or GPUs can also be used in computing and data mining/analytic problems.

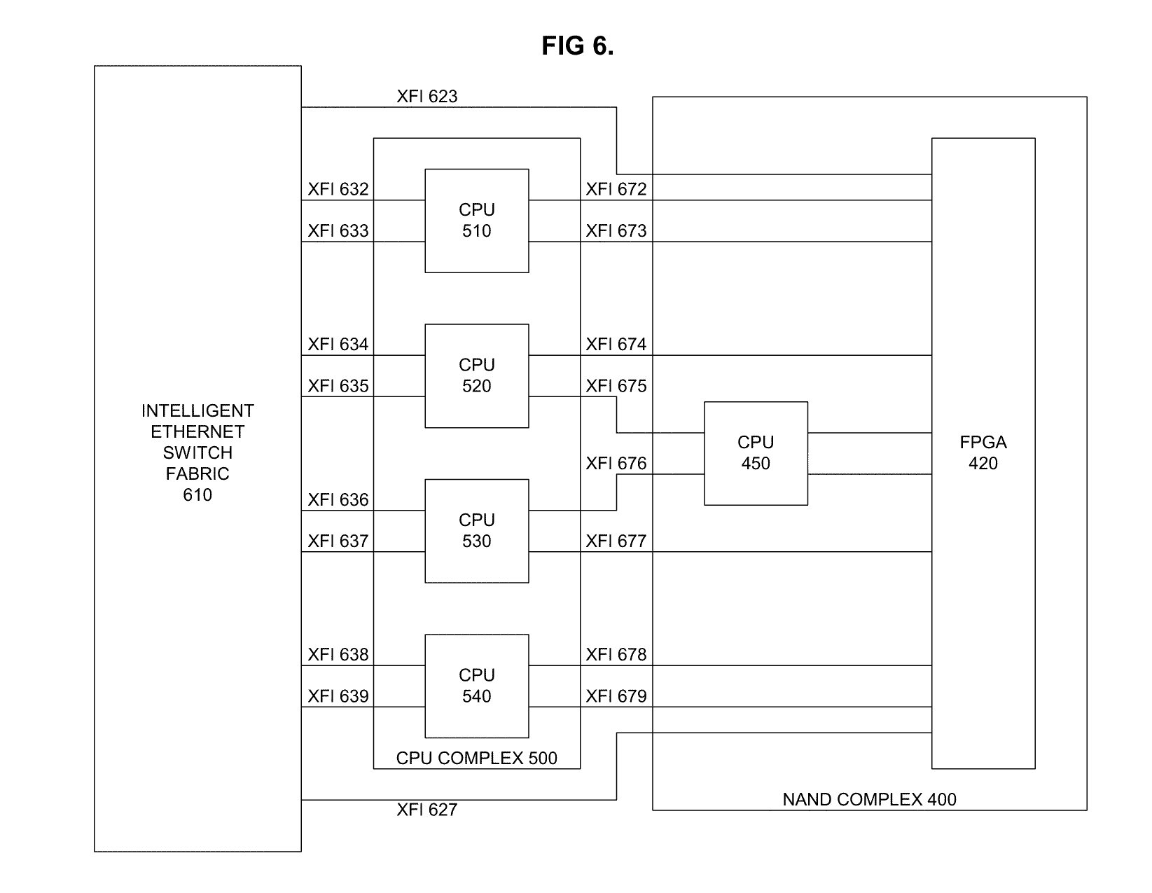

FIG. 6 is a generalized block diagram in accordance with one embodiment of the present invention that illustrates how the CPU complex 500 and NAND complex 400 communicate with each other and with other elements. Intelligent ethernet switch fabric 610 connects to CPU Complex 500 via XFI 632-639 and to NAND complex 400 via XFI 623-627. This allows each of CPU complex 500 and NAND complex 400 to connect into intelligent ethernet switch 610 and provide communications. Not shown on this generalized diagram is that ethernet switch fabric 610 also communicates outwardly to SFP+ ports 303 and QSFP ports 307, as well as to a multiplicity more CPU complex 500s and NAND complex 400s. NAND complex 400 also has private communications to one or more CPU complex 500. In the embodiment shown, a single NAND complex 400 is interconnected to a single CPU complex 500. Intelligent ethernet switch fabric 610 can be thought of as a set of internally cross coupled intelligent network switches 313 and 317. Those skilled in the art will recognize that there are a number of ways of interconnecting between the NAND complex 400s and CPU complex 500s and that FIG. 6 and subsequent figures are not intended as a limitation of the present invention.

Let us say that a request comes in from QSFP ports 307 via 40 GE into intelligent ethernet switch fabric 610 from the internet. Let us further define that the request is to send a photo stored somewhere in a NAND complex back across the internet to the original requestor. Note this is the same example used in reference to FIG. 1, above. At least two methods exist in the embodiment shown in FIG. 6 to get the request from the intelligent ethernet switch fabric 610 to a particular NAND complex 400. First, if the tables are set up correctly in intelligent ethernet switch fabric 610 so that it inherently knows without further interaction where the photo is located, then it may send the request directly from itself to the appropriate NAND complex 400 via XFI 623 or XFI 627. This method is deeply advantageous because there is no extra “processing” of the request except in the hardware of FPGA 420 in NAND complex 400. This method even bypasses CPU 450 in NAND complex 400. The logic within FPGA 420 is able to gather the required information from the ECN 402-418, and then send the photo back across XFI 623 or XFI 627 to intelligent ethernet switch fabric 610, and thus back across the internet to the requestor. Contrast this simplicity with the enormously inefficient complexity of FIG. 1 to accomplish the same task.

The second method of access is when intelligent ethernet switch fabric 610 does not have enough information to properly forward on the request directly to NAND complex 400 and instead must ask for help from one or more CPU Complex 500. In this case, Intelligent Ethernet Switch Fabric 610 determines which CPU in a particular CPU Complex 500 is least busy, along with which route between Intelligent Ethernet Switch Fabric 610 and CPU Complex 500 is least busy and sends the request on to one or more of CPUs 510, 520, 530 and/or 540 via one or more of XFI 632-639. For the sake of this example, assume that CPU 510 has been chosen to receive the request, and that XFI 633 is used to communicate the request. CPU 510 will do appropriate operations on the requested information and determine how to best complete the request. In the simplest of cases, CPU 510 knows that the data it needs is located in NAND Complex 400, and can use either or both of XFI 672, 673 to gather the data and craft a response back to Intelligent Ethernet Switch Fabric 610. It should be appreciated by those skilled in the art that the system is capable of far more complex operations as well. In another simple example, CPU 510 could determine that part or all of the information resides in another NAND Complex 400 that is interconnected to the present system via Intelligent Ethernet Switch Fabric 610, typically via QSFP Ports 307, and that CPU 510 can use one or more of XFI 632, 633 to communicate a request to another Intelligent Ethernet Switch Fabric 610, or another CPU Complex 500 to get that portion of the data it may house. One skilled in the art will also understand that it is possible that the present NAND Complex 400 has none of the data required and that CPU 510 will make as many requests through Intelligent Ethernet Fabric Switch 610 as needed to complete and aggregate the data back to the original requestor. That might be as the data comes in from the various agents, or a complete aggregation of all the data before sending it back to the original requestor on the internet.

It should become clear that exceptionally sophisticated algorithms are possible with structures such as these. Computing can be borrowed between CPU elements in CPU Complex 500, or from CPU 450 and/or FPGA 420 in NAND Complex 400, or even from other CPUs in CPU Complex 500s which are attached via interconnection between two different Intelligent Ethernet Switch Fabrics. This method of rich interconnection makes it possible to do truly cooperative computing on information at many different levels in the whole of a data center. In contrast, modern data centers are exceptionally connection poor with typically only a single or dual 10 GE link between them and a network switch. While data centers are upgrading to 40 GE between servers, it should be understood that this is still a “starved” connection because communication uses switch bandwidth in ways that the switches are not designed to handle. The result is a model of computing which tends to keep the elements more tightly coupled within a small set of information in the data center. This in turn both limits performance, and reliability. The present invention is strongly superior expressly because it permits a full and direct inter communication between many different kinds of elements. This eliminates a large number of latencies and power inefficiencies in the system.

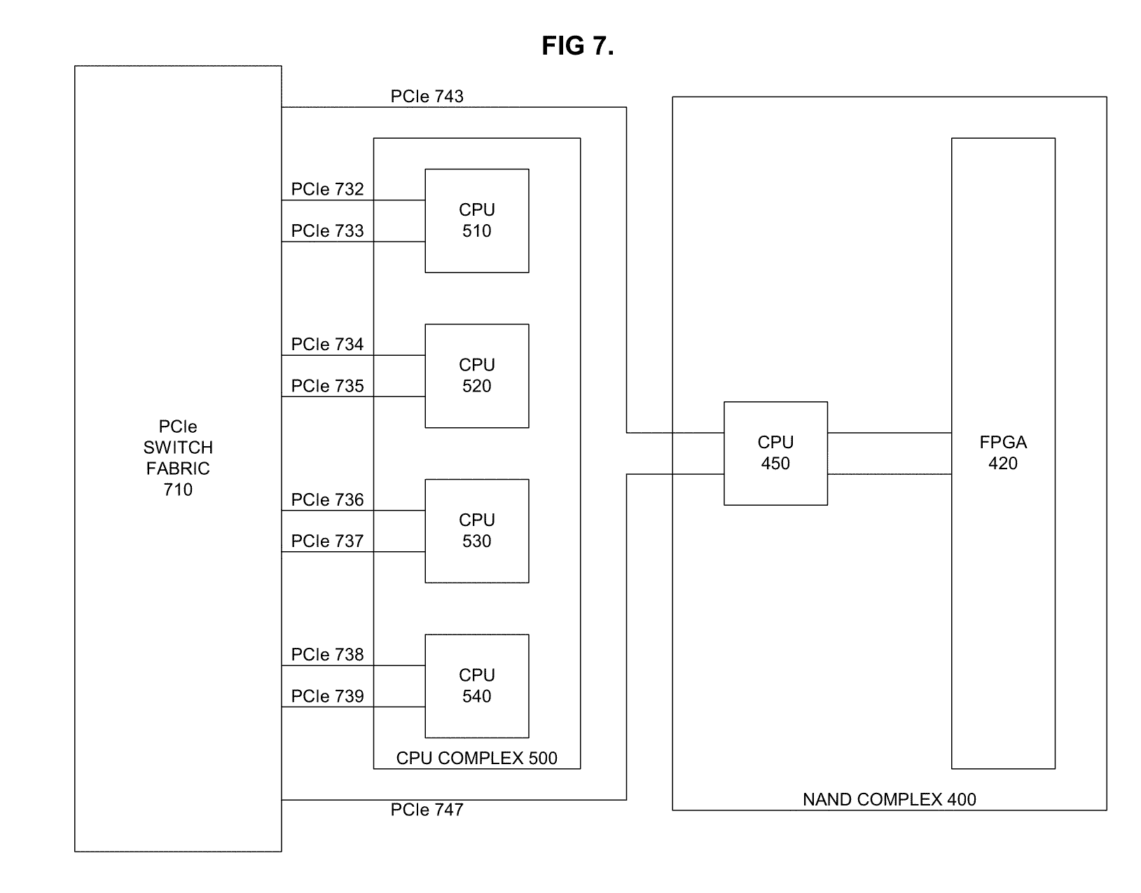

The present invention is designed to use Ethernet as a standard mode of communication between elements. Ethernet is intended to be used as the best mode means of communicating large amounts of information to any element in the system with very fast latencies and high data rate. Note that the system in this context is a group of elements such as shown on FIG. 6 that are interconnected with either 40 GE or 10 GE. However, the present invention also envisions a completely separate communications path that is designed to allow Inter Process Communication (IPC) between the elements of a single FIG. 6. To that end, FIG. 7 illustrates another portion of one embodiment of the present invention that utilizes PCIe as a means of communication between elements.

FIG. 7 is very similar to FIG. 6 in that both demonstrate a means of communication between NAND Complex 400 and CPU Complex 500 and some form of switch. In the case of FIG. 7, it is PCIe Switch Fabric 710. PCIe Switch Fabric 710 is unlike Intelligent Switch Fabric 610 because PCIe Switch Fabric 710 lacks the intelligence that Intelligent Switch Fabric 610 possesses. Instead, PCIe Switch Fabric 710 is organized as a more classical fat-tree switch, designed to provide non-blocking connectivity to every element within the system contained in FIG. 7. CPU 450 in NAND Complex 400 is able to communicate with PCIe Switch Fabric 710 through PCIe 743 and 747. Note that FPGA 420 in NAND Complex 400 might also have an interest in communicating via PCIe, depending upon the contents of FPGA 420; one skilled in the art will understand it is also possible and perhaps advantageous to have FPGA 420 communicate to PCIe Switch Fabric 710 (not shown). In much the same way, CPU Complex 500's CPU 510, 520, 530 and 540 can communicate to PCIe Switch Fabric 710 via PCIe 732-739.

The main advantage of having a separate network to the Ethernet network in the present invention is that there is that it can opportunistically use side band traffic between CPUs or other elements to update the contents of master tables, or to effect a particular quality of the larger information that is being sent down the Ethernet network. Simple examples of this include standard IPC traffic that multiple CPUs use to cooperate in an operating system. These messages are used to synchronize content, direct traffic, and report status and statistics. While this traffic can travel on the ethernet network, and in fact, will if there is a failure of communication on the PCIe network, the PCIe network is designed to provide parallel access over the Ethernet network. Importantly, removing this class of traffic from the Ethernet network results in much better utilization of the network because of how Ethernet works, as those skilled in the art will appreciate.

In one embodiment of the present invention, the PCIe network will be used to provide contextual update frames between CPUs and between the CPU Complex 500 and NAND Complex 400. For example, it was noted before that CPU 510 might be chosen by the Intelligent Network Switch Fabric 610 to receive a request from the internet to provide a specific photo back to the requestor. CPU 510 can use the PCIe network to help offload the searching for where the photo is by searching the the information context which houses location data. That context could be housed in multiple CPUs in CPU complex 500, or may be be across several CPU complex 500s. Having multiple CPUs cooperate to find the information helps to reduce the response time back to the original requestor. CPU 510 can also use the PCIe network to make inquiries to other CPUs in either the CPU Complex 500 or the NAND Complex 400 to accomplish a particular task such as providing status on a prior request. Those skilled in the art will recognize that having the low latency PCIe network in parallel to the Ethernet network provides a wide variety of different uses for the PCIe network that will depend on the specific task that the over all system is executing. For example, when the system is using CPU Complex 500 effectively as CPU servers and NAND Complex 400 effectively as storage servers, the use of the PCIe network is vastly different than if CPU Complex 500 and NAND Complex 400 are operating as a data mining engine. The context of the work being done by the overall system can thus be altered, even over time as the context changes over time, to make best use of each network for their best performance.

It should be noted that both FIG. 6 and FIG. 7 are conceptually illustrative diagrams to help understand the means of information flow and sharing between elements in a single system. They do not show the communication between larger numbers of these systems set to intercommunicate and interoperate with each other. Those skilled in the art will immediately understand that the use model for the system is highly variable, and it is only the specific and actual use of a whole system, typically comprised of a number of sub systems, that will limit what that particular system does. Note too that one unique factor of the present invention is that it permits large scale change in the way that each element and each part of the system can be used, including the ability to temporally change what any given element is doing.

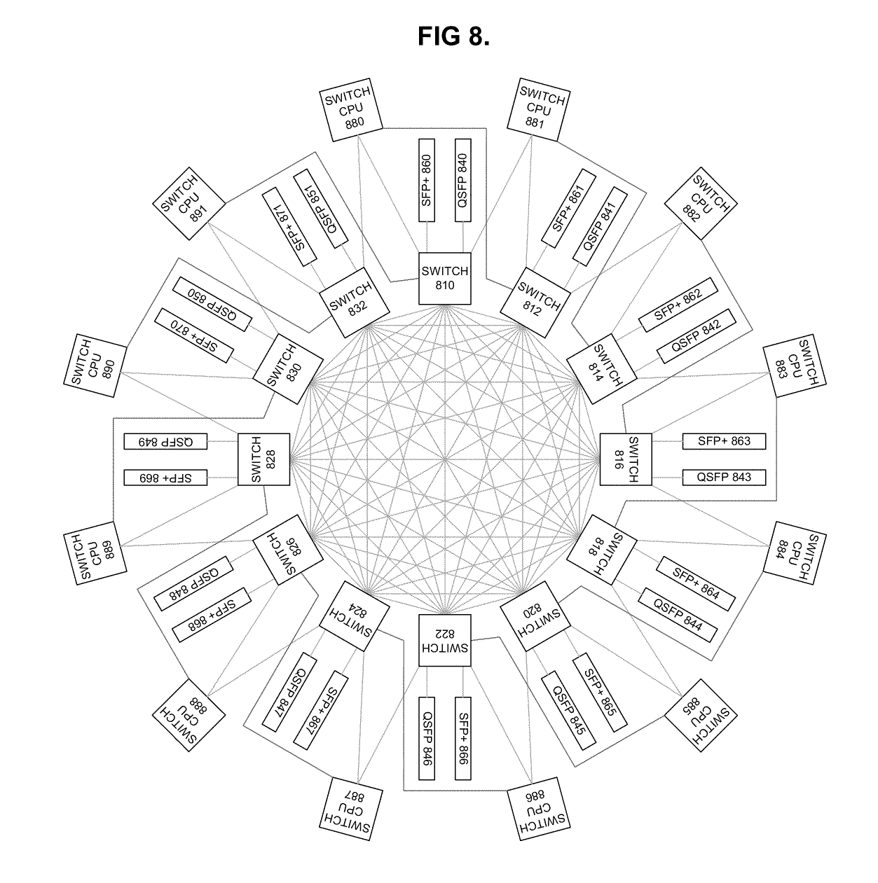

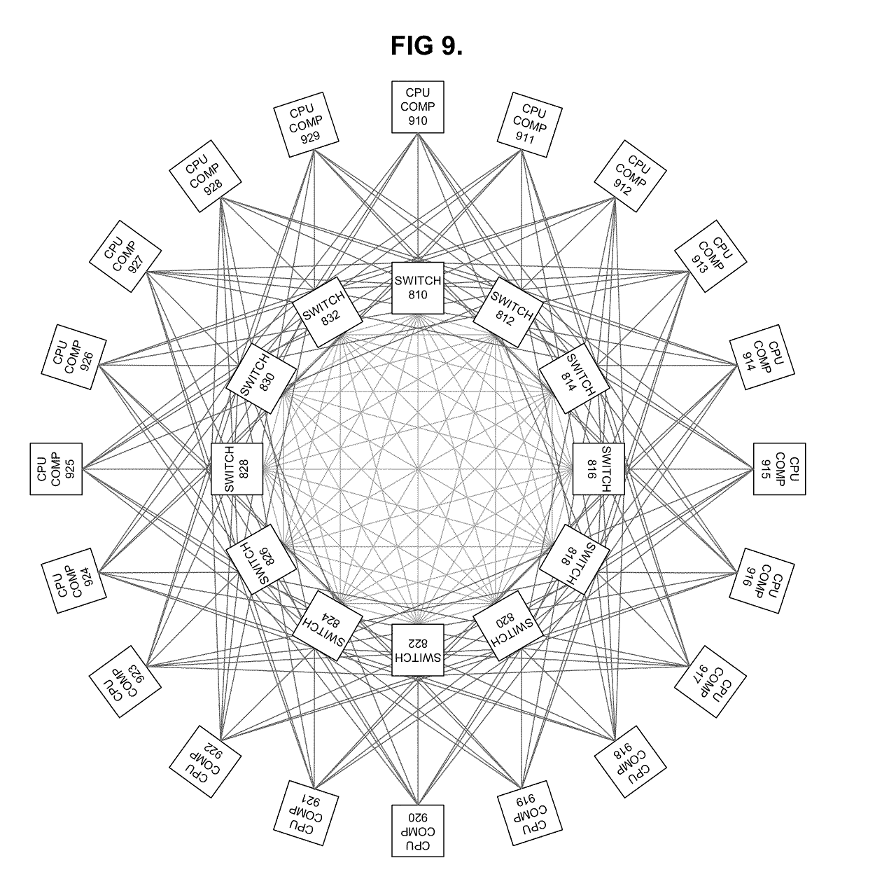

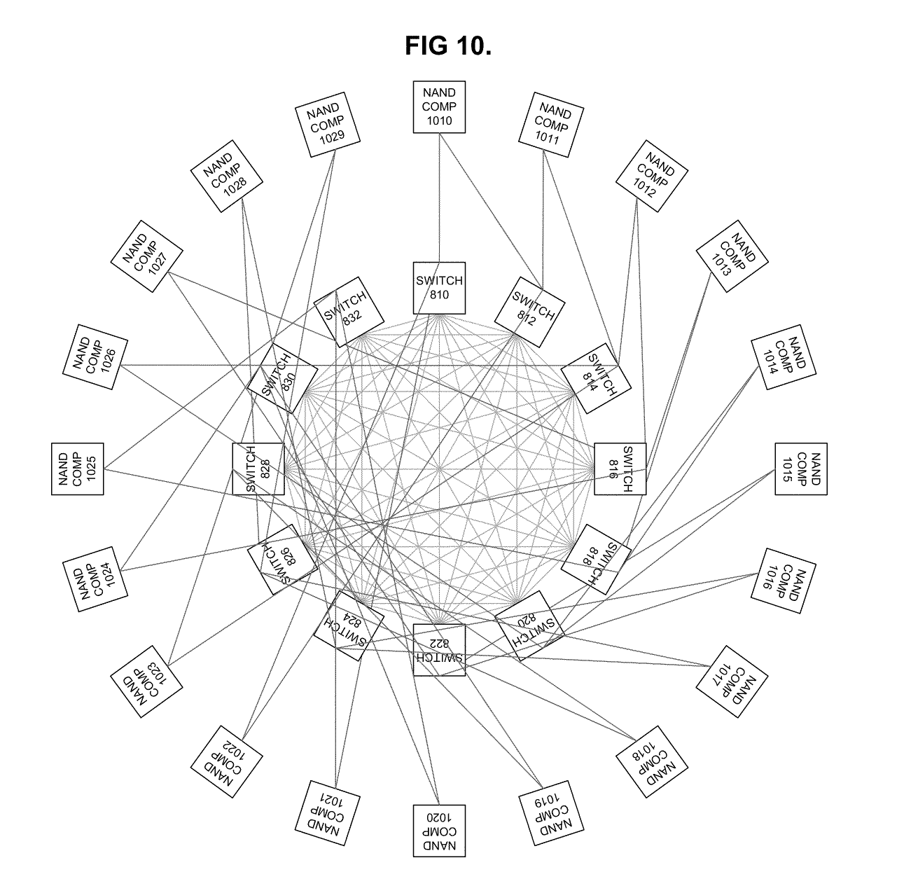

FIG. 8, FIG. 9, and FIG. 10 are differing views of one embodiment of the present invention Intelligent Ethernet Switch Fabric 610 in FIG. 6. Specifically, each of FIG. 8 to FIG. 10 shows a different aspect of how the network is connected in Intelligent Ethernet Switch Fabric 610. Beginning with FIG. 8, Switch 810, 812, 814, 816, 818, 820, 822, 824, 826, 828, 830 and 832 make up what can be thought of as the back bone of the ethernet switch functionality. It can be seen in FIG. 8 that each of Switch 810-832 can communicate with each other with a direct line of communication between each of Switch 810-832. This communication can be with single sets of connections, or multiples as best befits the occasion. It would also be possible as those skilled in the art will recognize to add additional layers of switches between Switch 810 to Switch 832 as the size of the network increases.

Switch 810-832 also have external connections, akin to SFP+ Ports 303 and QSFP Ports 307 of FIG. 3. In FIG. 8, these connections are shown more as they really are where each switch has one or more QSFP 840 to QSFP 851s attached to each Switch 810-832. Similarly, each Switch 810-832 has one or more SFP+ 860 to SFP+ 871s attached. The QSFPs 840-851s provide 40 GE connectivity to the outside world while SFP+ 860-871s provide 10 GE connectivity to the outside world from Switches 810-832. In the present invention, it is presumed that the 40 GE external connections will be used to tie together systems to craft a larger overall system whereas 10 GE external connections will often be used as a means of ingress and egress from the outside world. e.g. the internet.

Switch 810-832 also have Switch CPUs 880-891 attached to them. Switch CPUs 880-891 are designed to provide additional intelligence over and above that which is native in Switch 810-832. For example, if Switch 810-832 were only capable of dealing with layer 3 switching commands, Switch CPUs 880-891 could be used to provide layer 4 functionality. Note this example is purely illustrative, and not intended to limit the present invention. Having CPUs dedicated to the task of administering the switch is highly valuable because it allows CPUs in other areas such as CPU Complex 500 or NAND Complex 400 to not have their work flow interrupted. Note that Switch CPUs 880-891 have their own memory subsystems attached, not shown, as one skilled in the art will recognize.

Switch CPUs 880-891 in the preferred embodiment are used to help setup, manage and tear down the routing tables contained in Switch 810-832, and to provide data plane processing of transactions that are too complex for Switch 810-832 to handle by themselves. This interaction might be one where Switch 810-832 offloads the transaction entirely to Switch CPUs 880-891, or where only part of the transaction is offloaded. Which method is used depends entirely upon the traffic flow into and out of Switch 810-832, and thus may be assumed to vary over time.

FIG. 9 shows a different view of the same Intelligent Ethernet Switch Fabric 610 as FIG. 8 and FIG. 10. In FIG. 9, the Switch 810 to Switch 832 are still shown as being interconnected, but now CPU Complex 910 to CPU Complex 929 are shown connected to Switch 810 to 832. In the preferred embodiment, one or more connections from, say CPU Complex 910 is made to one or more of Switch 810-832. In the example shown in FIG. 9, CPU Complex 915 is shown with at least one connection to Switch 812, 814, 816, 818, and 820. Similarly, CPU Complex 916 is shown with at least one connection to Switch 814, 816, 818, 820 and 822. In one embodiment of the present invention, the connections between a CPU Complex 910-929 and Switch 810-832 involving having multiple connections between the CPU Complex and the Switch. Part of the reason for this is to allow fail over communication between any given CPU Complex and any given Switch. Another important reason though goes back to FIG. 5, where CPUs 510-540 have multiple XFI connections to Connector 550. It can be seen from FIG. 5 that there are multiple ways for each CPU 510-540 to get into the Switch 810-832. These means are used both for failover (at least two of Switch 810-832) are reachable by each CPU 510-540, and for crafting additional bandwidth into/out of CPU 510-540.

FIG. 10 shows a different view of the same Intelligent Ethernet Switch Fabric 610 as FIG. 8 and FIG. 9. In FIG. 10, the Switch 810-832 are still shown as being interconnected, but now the NAND Complex 1010-1029 are shown connected to Switch 810 to 832. In the one embodiment, one or more connections from each NAND Complex are connected to Switch 810-832. For example, FIG. 10 shows that NAND Complex 1010 connects to both Switch 810 and Switch 812. Similarly, NAND Complex 1011 connects to both Switch 812 and Switch 814. Those skilled in the art will recognize that there are many possible ways to interconnect a NAND Complex to a Switch. In the preferred embodiment a single NAND Complex will connect to at least two different Switches so that communication redundancy and double bandwidth can be achieved. Connecting the NAND Complex 1010-1029 directly to a Switch 810-832 is the means that allows the example above of the Intelligent Ethernet Switch Fabric 610 the direction connection into the NAND Complex 400 of FIG. 6.

Those skilled in the art will recognize that many different interconnection topologies are possible. That is, the specific connections between NAND Complexes, CPU Complexes, SFP+ Ports, QSFP Ports, and Switch CPUs can be done in a variety of ways to optimize for a particular system characteristic. The present invention is not intended to be limited in any way through the examples shows in the above figures.

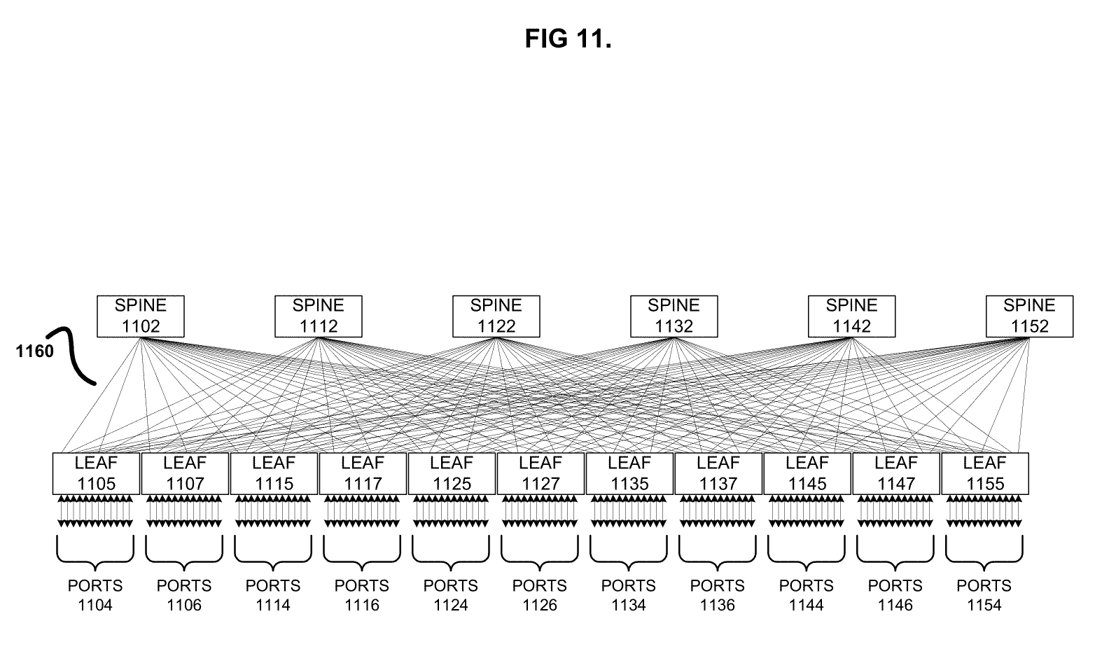

FIG. 11 shows an embodiment of the present invention implementing a Clos or fat-tree switch for the PCIe Switch Fabric 710. In a fat-tree switch, Ports 1104-1154 exist at the bottom of the diagram. Each port is a single PCIe connection between a Leaf Switch 1105-1155 and a PCIe device such as CPU 510-540 in FIG. 7. The Leaf Switch 1105-1155 then interconnect to Spine Switches 1102-1152. This configuration is well known in the art, although it is not normally applied to PCIe. The advantageous use of a fat-tree switch for the PCIe Switch Fabric 710 is so that every CPU Complex or NAND Complex which needs access to PCIe can speak to every other CPU Complex or NAND Complex attached to PCIe Switch Fabric 710.

Those skilled in the art will recognize that many different interconnection topologies are possible for PCIe Switch Fabric 710. The preferred embodiment of the present invention uses the fat-tree switch approach to minimize latency and maximize performance. Fat-tree switches are known to be non-blocking so long as other ports do not wish to speak to a port already communicating with another port. So if two ports wish to have access to two different other ports, the fat-tree switch allows them to communicate completely in parallel with one another. Another embodiment uses two sets of fat-tree switches in order to handle the case of failing of a single leaf or spine switch. Alternate implementations are possible that require less switches to populate the final switch but also reduce the bandwidth and capability of the final switch. The fat-tree switch topology is intentionally chosen in the preferred embodiment to ensure as much non-blocking communication as possible between all PCIe ports.

FIG. 12 illustrates one embodiment of the present invention representing a partial block diagram for Motherboard 1200 of an industry standard height 2U chassis. FIG. 12 shows seventeen total NAND Complex 400s shown as NAND Complex 1201 to NAND Complex 1217. Additionally, FIG. 12 shows twenty total CPU Complex 500s shown as CPU Complex 1231 to CPU Complex 1250. Motherboard 1200 also contains a PCIe Switch Fabric 710, a Intelligent Ethernet Switch Fabric 610, SFP+ Ports 303 and QSFP Ports 307. In the embodiment shown in FIG. 12, Motherboard 1200 has NAND Complex 1201 and 1202 talking directly to CPU Complex 1231 via eight separate XFI connections, four each to NAND Complex 1201 and four each to NAND Complex 1201. NAND Complex 1201 also has two connections of PCIe to the PCIe Switch Fabric 710 and six total connections to Intelligent Ethernet Switch Fabric 610. Similarly, NAND Complex 1202 has two connections of PCIe to the PCIe Switch Fabric 710 and six total connections to Intelligent Ethernet Switch Fabric 610. CPU Complex 1231 has four total PCIe connections to PCIe Switch Fabric 710 and eight total connections to Intelligent Ethernet Switch Fabric 610. CPU Complex 1231 is intended, in this embodiment to control the communication with two different NAND Complex 400s, in this case NAND Complex 1201 and 1202. Those skilled in the art will understand that this representation is not the sole representation possible. Many different topologies might exist to accomplish some specific purpose. In the preferred embodiment, the loading of CPUs 510-540 is analyzed to understand how many CPU 450s and FPGA 420s each of CPU 510-540 is capable of administering. It is possible to add more of NAND Complex 400s and another CPU Complex 500 in FIG. 12 as befits the space, power, and performance requirements. The NAND Complex 1216 and 1217 are connected to CPU Complex 1250 and PCIe Switch Fabric 710 and Intelligent Ethernet Switch Fabric 610 in the same was as NAND Complex 1201/1202 and CPU Complex 1231 were described above.

CPU Complex 1243 is included in FIG. 12 to show that the total number of CPU Complexes and NAND Complexes need not be the same. In the embodiment shown in FIG. 12, there are only seventeen NAND Complexes, but there are 20 CPU Complexes. In the preferred embodiment, some CPU Complexes may not be connected to NAND Complexes at all, as is shown by CPU Complex 1243. This allows CPU Complex 1243 to act as the CPU for the switches 810-832 contained in FIG. 8-10. Those skilled in the art will also realize that it is also possible to have more NAND Complexes than CPU Complexes.

Motherboard 1200 is shown with these seventeen NAND Complex 1201-1217 and twenty CPU Complex 1231-1250. In the preferred embodiment each NAND Complex and each CPU Complex would be on a separate, but replaceable card on Motherboard 1200. More specifically, in the preferred embodiment, the NAND Complex 1201-1217 are cards which can be removed from the front panel of the 2U Chassis that Motherboard 1200 is mounted in. The twenty CPU Complexes 1231-1250 can similarly be removed from Motherboard 1200, albeit through the top of the chassis, in the preferred embodiment. Each CPU Complex is another card that is mounted to Motherboard 1200. The PCIe Switch Fabric 710 would also be mounted on one or more cards that allow the entire PCIe Switch Fabric 710 to be removed from Motherboard 1200. Similarly, Intelligent Ethernet Switch Fabric 610 would be mounted on one or more cards that allow the entire Intelligent Ethernet Switch Fabric 610 to be removed from Motherboard 1200.

In the preferred embodiment, the reason that the NAND Complex, CPU Complex, PCIe Switch Fabric, and Intelligent Ethernet Switch Fabric are all on separate cards is because they are intended to be changed over time. There are a few important reasons these elements are replaceable. First, if a particular NAND Complex or CPU Complex card were to cease functioning, it could be replaced without the cost of replacing the entire structure. For systems which need to run in data centers, that is a very important aspect of the design. In fact, the design should allow for the practice known as “hot pluggable” which means that a card can be replaced while the power is on and it will not harm the system. Another reason that cards are designed to be replaceable is to allow technology to change over time but not obsoleting the product. For example, in 2013 technology, NAND is the preferred choice for solid state storage. In the future a technology like Phase Change Memory (PCM) might replace NAND as the preferred choice for storage. In such a case, the NAND Complex 400 shown in FIG. 4 would be altered to utilize the new solid state PCM as storage, and would then become PCM Complex 400 instead. What is true for NAND Complex 400 is also true for CPU Complex 500. While technology is constantly changing in CPUs, the more interesting aspect of a removable card is to get the right CPU for the job. Those skilled in the art will understand that different CPUs with potentially different Instruction Set Architectures (ISAs) could be put down in different CPU Complexes, or even within a single CPU Complex. A third reason for incorporating cards, in particular for PCIe Switch Fabric 710 and Intelligent Ethernet Switch Fabric 610 is that the entire communication network now has the ability to be changed. It can be changed by technology, such as switching from Ethernet to Infiniband, or by switching speed from say 10 GE to 100GE. More interesting though is the ability to change the actual topology, capability, performance, power and cost of the network simply by replacing cards.

Those skilled in the art may recognize that the card based structure of the present invention is similar to the way that a modern data center is created. Take the network for example. The network of a data center, as illustrated in FIG. 1 is made from a number of discrete switch elements. They are replaceable as a unit to add capability, functionality, or to alter the structure of the network. Configuring the structure requires a human being pulling out one or more network connections and making new ones, or of installing equipment, configuring it, and connecting it into the data centers network. In the case of the present embodiment, this is done on the one or more cards that make up either or both of PCIe Switch Fabric 710 or Intelligent Ethernet Switch Fabric 610. What is unique in the case of the present invention is that this functionality is far more contained, and thus far easier to field service. In the preferred embodiment, it is also a vastly richer set of interconnections than present data centers allow for due to their cost constraints. Similarly, one can imagine the CPU Complex 500 card on Motherboard 1200 as being analogous to CPU cards plugged into a backplane chassis of a CPU server. In both cases, the cards can be upgraded or changed. What is different in the case of rack mounted CPU servers with removable CPU cards is that the backplane they plug into inherently limits the communication to one particular set of communication elements. Since the present invention can alter its network, up to the limits of the connections going across connector 550, it is possible to completely alter the interconnection with Motherboard 1200. This is not possible in prior art systems. Further, NAND Complex 400 cards can be thought of as being independent storage servers connected onto Motherboard 1200. Like the CPU Complex 500 cards, the actual network interconnecting these is not entirely limited as it would be if such functionality could be built into prior art systems.

It should be understood that the means of connection, the number of connections, the topology of the connections, and even what is being connected can be altered in the present invention. While this is somewhat analogous to prior art systems, no one system has all of the features described above contained in a single, scalable unit. The present invention was expressly designed to combine each of the three major functional elements of a data center (computing, storage and networking) into a tightly coupled, deeply vertically integrated structure that provides multiplicative substantial value over any known prior art system, as cited above.

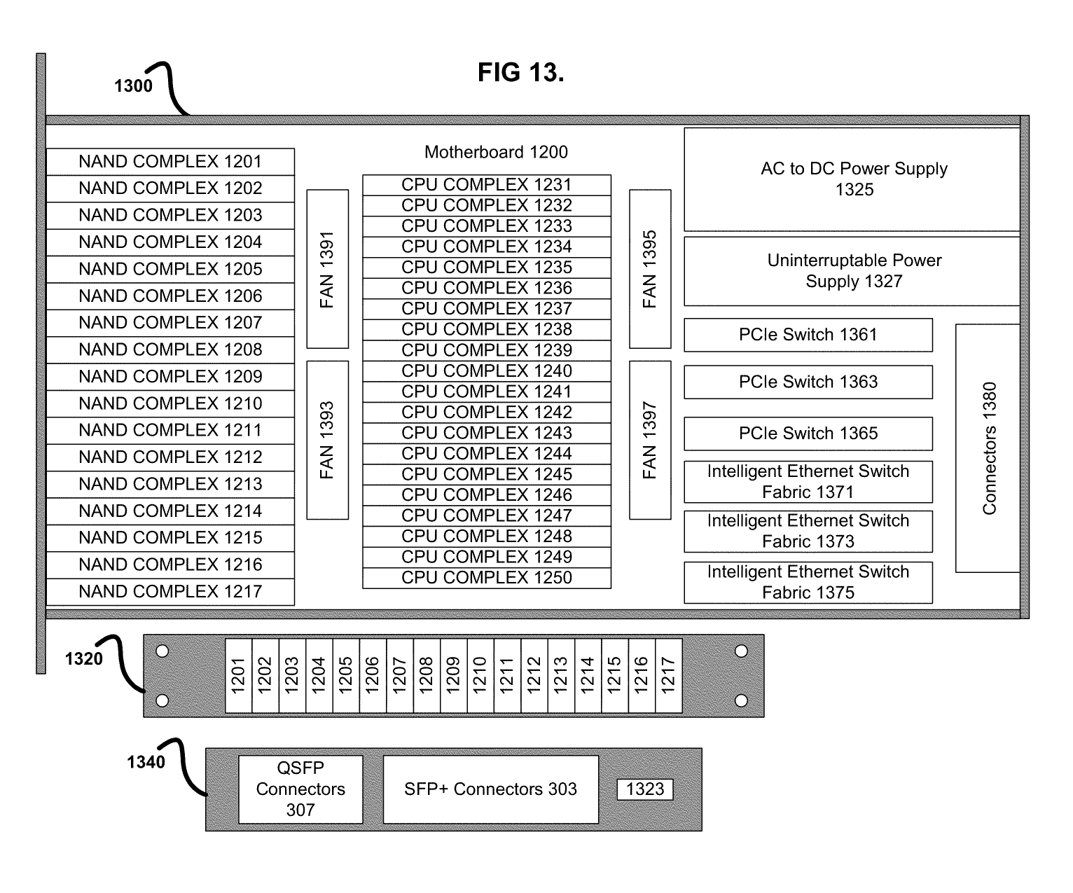

FIG. 13 shows one embodiment of an industry standard 2U chassis. Chassis 1300 has a Front Panel 1320 and a Rear Panel 1340. Rear Panel 1340 is where AC to DC Power Supply 1325 has Power Connector 1323 come through to allow AC and/or DC power to pass into Chassis 1300 to provide power for the chassis. Rear Panel 1340 is also where SFP+ Connectors 303 and QSFP Connectors 307 come through Chassis 1300 to allow for interconnection with 10 GE and 40 GE, respectively. Front Panel 1320 allows NAND Complex 1201 to NAND Complex 1217 to be removed from Chassis 1300 through the front of Chassis 1300.

Chassis 1300 itself consists of the physical structure of the chassis of a suitable material such as steel, aluminum or plastic, along with Motherboard 1200 which in turn houses NAND Complex 1201 to 1217, CPU Complex 1231 to 1250, FANs 1391-1397, AC to DC Power Supply 1325, Uninterruptible Power Supply 1327, Power Supply Connector 1323, Connectors 1380 which contain SFP+ Connectors 303 and QSFP Connectors 307, PCIe Switch Fabric cards 1361 to 1365, and Intelligent Ethernet Switch Fabric cards 1371 to 1375. In some embodiments, AC to DC Power Supply 1215 is more than one supply, where each of the supplies may be hot-pluggably removed from Chassis 1300 while Chassis 1300 remains powered.

In one embodiment, one or more rows of FAN 1391 to 1397 are used to remove waste heat from the system, typically through vent holes in either Rear Panel 1340 or on the side panels, vent holes not shown on FIG. 13. Those skilled in the art will recognize there are a number of ways to accomplish adequate cooling. Notably, the present invention is counter intuitive because it intends to mash up a large amount of heat in a very small space. This is generally deeply avoided in the industry because it adds cost and complexity to the design. However, the present invention trades off the extra cost and complexity of addressing the heating issues against the cost of the prior art equipment that it replaces. This is a deeply important aspect of the invention because implementation choices become design architecture choices due to the tradeoffs which engineers and designers have to make. By collapsing together computing, storage and networking, and thus enormously reducing both cost, volume, and power required for an equivalent prior art system, the collapsing itself offers new insights into methods of solving both business and technical issues that heretofore have not been implemented in any prior art system.

NAND Complex 1201 to 1217 collectively make up the storage subsystem of Chassis 1300. Similarly, CPU Complex 1231 to 1250 make up the computing subsystem of Chassis 1300. PCIe Switch Fabric cards 1361 to 1365 and Intelligent Ethernet Switch Fabric cards 1371 to 1375 collectively make up the networking subsystem of Chassis 1300.

Chassis 1300 would be typically operating in a data center environment. These environments are uniquely different from the typical home computer because Chassis 1300 can not be down at any time it is in operation in the data center environment. Typically, a data center will employ one or more massive uninterruptible power supplies (UPS) which will provide AC power to the CPU and storage servers as well as network to protect against power failure by providing enough power to start massive on-site power generation equipment. This equipment is enormously expensive, and must be maintained so that it can be relied upon if a power failure to the building occurs.

The present invention offers an alternative method of approach which in some data center circumstances can offer far less cost yet perform similarly to the massive generator and UPS systems found at most data centers. In particular, inside Chassis 1300, in one embodiment of the present invention, Uninterruptible Power Supply 1327 is added to provide sufficient power to allow for Chassis 1300 to shut down in an orderly manner, or otherwise bridge power until either main power is restored, or locally generated power is connected to Chassis 1300. Having Uninterruptible Power Supply 1327 is a significant departure over prior art systems because of the effect it has on the software required to run Chassis 1300s storage subsystem.

Present NAND storage control software is required to be complex because if power is lost while the NAND is being used, information can be lost. Companies spend enormous resources on the software used to control the storage subsystem, and in turn large amounts of software run on CPUs to control the subsystem. Worse still, the prior art practices require very complex structures be written to the NAND in case the power is lost so that information can be restored once power is restored. The present invention looks at the world radically differently. Instead, it asks the question what happens if I can always guarantee power to the storage subsystem? May the software, and software structures be simplified? The answer is an unqualified yes. By changing the operating rules of the storage subsystem, vastly simpler software and vastly less processing is required which in turn boost performance, decreases latency, and even results in longer life for NAND memory technology because it results in less writes and rewrites to the NAND. The present invention solves the power problem by providing sufficient power once AC power has failed to at least orderly shut down the storage subsystem. It does this by adding Uninterruptible Power Supply 1327. Those skilled in the art will understand that UPS 1327 could in fact be external to Chassis 1300. However, it is advantageous to be local to Chassis 1300 because of finer grain control over the use of the power, and the fact that even if someone were to trip over the power cord to Chassis 1300, power would still be available to accomplish and orderly shutdown.

Earlier, it was indicated that the network subsystem consists of PCIe Switch Fabric 710 and Intelligent Ethernet Switch Fabric 610. Chassis 1300 shows a more refined example of how those might be physically implemented. For example, FIG. 8, FIG. 9, and FIG. 10 demonstrate one embodiment of the Intelligent Ethernet Switch Fabric 610. The preferred embodiment understand that 3-dimensional volume is at a premium in Chassis 1300 and so implements Intelligent Ethernet Switch Fabric 610 as one or more cards on Chassis 1300; in this case as Intelligent Ethernet Switch Fabric cards 1371 to 1375 collectively make up Intelligent Ethernet Switch Fabric 610. Similarly, PCIe Switch Fabric cards 1361 to 1365 collectively make up PCIe Switch Fabric 710, as illustrated in one embodiment by FIG. 7.

Connectors 1380 in some embodiment is actually one or more cards that together house SFP+ Connectors 303 and/or QSFP Connectors 307. Being able to change the actual connectors that go out the back is another advantage of the present invention. Since the network switch technology can and will change over time, recognizing that connector technology will also change and allowing for it is an important aspect of the present invention. While not all embodiments require Connectors 1380 to be removable from Chassis 1300, it is a strong advantage over prior art systems to allow for doing so.

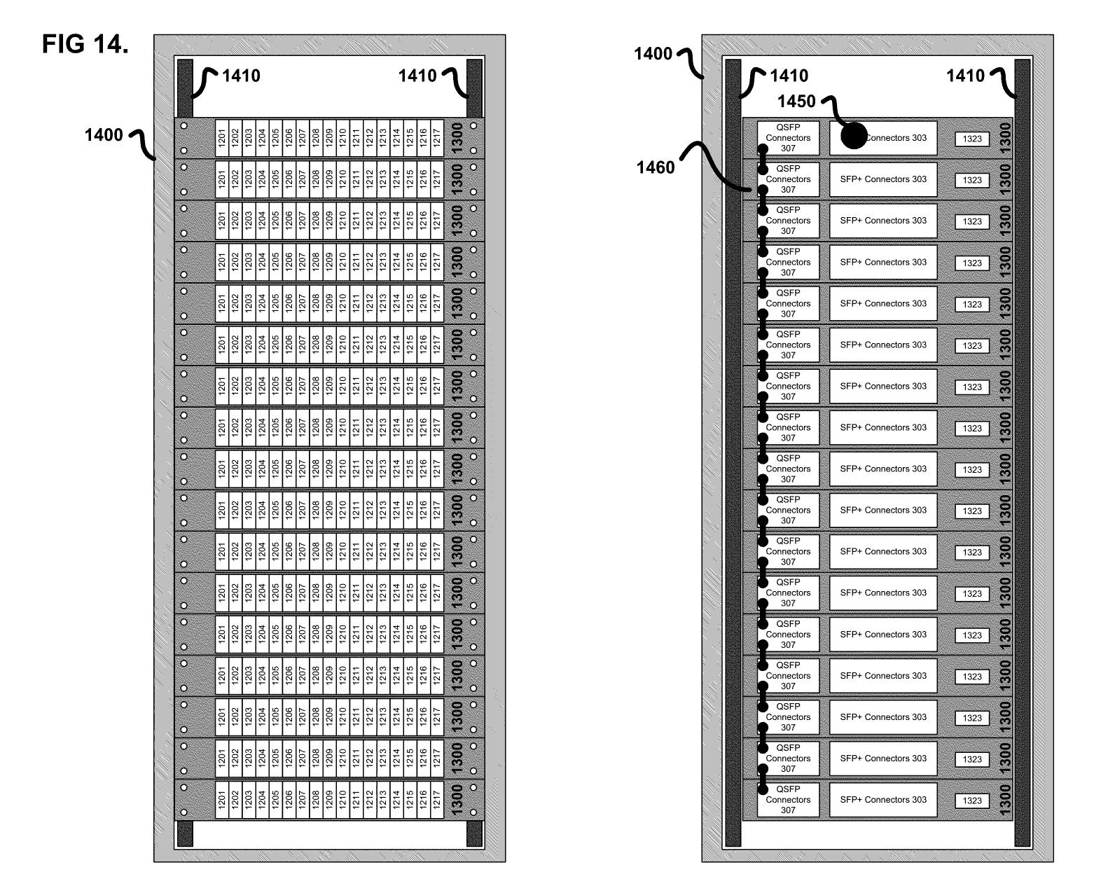

FIG. 14 demonstrates an example of a set of seventeen Chassis 300 in a single industry standard 19″ or 23″ wide rack. Rack 1400 houses a set of Rails 1410 for which the front panel of Chassis 1300 typically would mount to hold Chassis 1300 in place in Rack 1400. There are a number of well known techniques, not covered here, for placing and keeping Chassis 1300 in Rack 1400. Rack 1400 has both a front side, illustrated on the left side, and a back side as illustrated on the right side in FIG. 14. In some embodiments, there may or may not be side, top and/or bottom panels to Rack 1400.

Rack 1400 must communicate with the outside world, generally the internet. To do so, Chassis 1300 offers a number of 10 GE ports via SFP+ Connectors 303. In FIG. 14, a single example of External 10 GE 1450 is shown to make the example clearer. In a typical data center, there would be many External 10 GE 1450 connections to many Chassis 1300. External 10 GE 1450 would be typically connected directly to the Internet, or perhaps to a private data line between the data center and a specific customer.

Internal 40 GE Backbone Connection 1460 is illustrated very simplistically in FIG. 14. Internal 40 GE Backbone Connection 1460 would be one or more 40 GE lines that interconnect Chassis 1300s. Note that the connections can be between any Chassis 1300 on any rack. Those skilled in the art will understand that the actual pattern of connection between Chassis 1300s can be done in a large number of ways. However, the preferred embodiment of the invention is designed in such a way that within a single Rack 1400, the Internal 40 GE Backbone Connections 1460 will provide at least one 40 GE connection between every Chassis 1300 in Rack 1400.

Data centers have two kinds of network bandwidth to consider: First, the bandwidth ingressing/egressing to/from the data center and the outside world; second, the bandwidth that is used inside the data center to move information about and complete whatever tasks the data center is supposed to accomplish. Typical data centers have a ratio of roughly 80% of the network traffic staying inside the data center versus roughly 20% of the network traffic going to the outside world. What quickly becomes clear is that the Internal 40 GE Backbone Connection 1460 is very important to how the overall system is created from many Rack 1400s consisting of many Chassis 1300 per each Rack 1400. The preferred embodiment of the present invention was expressly designed so that external network switches were not required. Rather, all the required switching would be done using the 40 GE network. To that end, the preferred embodiment has sufficient numbers of 40 GE connections, via QSFP Ports 307 to allow the aforementioned each Chassis 1300 connecting with every other Chassis 1300 within the same Rack 1400, but also to allow for every Chassis 1300 in Rack 1400 to communicate with other Chassis 1300s in other Rack 1400s. In the simplest example, one can imagine where there are three Rack 1400s, and in the center Rack 1400, each Chassis 1300 connects to other Chassis 1300s in that Rack 1400, but also allows each Chassis 1300 to communicate to the Chassis 1300 at the same height in the leftmost and rightmost Rack 1400s such that a 2D array is formed. Those skilled in the art will understand this simplistic example is just that—simplistic and an example. The preferred embodiment of Chassis 1300 was designed to allow every Chassis 1300 to communicate with every other Chassis 1300 in the same Rack 1400, and to allow each Chassis 1300 sufficient additional 40 GE ports to connect in more traditional network topologies such as 3D torus, spanning tree, fat tree or many other appropriate structures. The best mode of Chassis 1300 is when it uses a fat-tree inter Rack 1400 and a 3D torus between Rack 1400s.

Power is supplied to each Chassis 1300 via Power Connector 1323 on each Chassis 1300. There are many well known means of connecting power to each Chassis 1300 and are not covered here.

When Rack 1400s are interconnected with one another, typically by interconnecting Internal 40 GE Backbone Connection 1460s between the Rack 1400s, large scalable data centers can now be built. The preferred embodiment was designed to allow for adding as many Rack 1400s with as many Chassis 1300s as are needed to solve the particular problem the data center is seeking to solve. Importantly, an aspect of this preferred embodiment is that the data center can be expanded or contracted post facto without requiring additional resources other than the extra Rack 1400s and Chassis 1300s being added (or taken away).

Because the network is designed to be predictable and homogenous, it can actually be relied upon by software. This is vastly superior to existing prior art because there is no requirement that the network be predictable or homogenous whereas the present invention enforces either a limited or complete degree of structure, according to how the data center desires to be set up.

Increasingly, large parts of data centers are being used to accomplish data mining. For example, when checking out at grocery store, data mining is used to identify the items purchased in this transaction in order to provide a coupon for future use based upon the present purchase and what is known about past purchases. These can be very sophisticated algorithms that identify uniquely marketable traits. Using data mining, people will get more accurately reflective information that relates to the specific data being mined. Some of these algorithms are enormously complex and requires extraordinarily large amounts of computing, storage and networking to be effective.

One of the major issues with prior art data centers is that they are almost never homogenous. The effect of this simple reality is that little to no effort is made in writing more efficient software that could make excellent use of the locality of data via a homogenous network. It is demonstrable in bioinformatics, for example, that the lack of homogeneity deeply affects the execution time, response time, and in some cases, the quality of the results. The preferred embodiment of the present invention actively and intentionally seeks to set, maintain and keep homogeneity in all aspects of the computing, storage and networking expressly so that a new class of software can be created which relies deeply upon that homogeneity to solve more complex problems in less time, with less power, and for less money than prior art systems do.

Although the invention has been described with reference to particular embodiments thereof, it will be apparent to one of ordinary skill in the art that modifications to the described embodiment may be made without departing from the spirit of the invention. Accordingly, the scope of the invention will be defined by the attached claims not by the above detailed description.

What is claimed is:

1. An apparatus that contains the following elements:
a. computing element having means to communicate to other elements within the apparatus; said computing element consisting of one or more computing functions built from one or more technologies including Central Processing Units (CPUs), Graphics Processing Units (GPUs), or Field Programmable Gate Arrays (FPGAs); said computing means further having augmented intelligence contained within or beside the computing means to effect additional work on information being processed by said computing means; said computing element having a means to intelligently communicate outside the element;
b. and a solid state storage element having means to communicate to other elements within the apparatus; said solid state storage element having a programmable hardware intelligence and programmable software intelligence to effect useful work directly within the solid state storage element; said solid state storage element being capable of the non-volatile storage of data; said solid state storage element having a means to intelligently communicate outside the element;
c. and a network element having means to communicate to other elements within the apparatus; said network element having a local hardware intelligence within the network element and augmented by additional software intelligence; said network element being capable of accepting requests and data from either outside the apparatus or from inside the apparatus and responding to said requests and data without the intervention of other elements in the apparatus; said network element having the means to communicate intelligently with the other elements both inside and between other apparatuses, including the ability to intelligently communicate outside the system formed by one or more interconnected apparatus;
d. and a means to interconnect one or more said computing elements, one or more said solid state storage elements, and one or more network element;
e. and a means to remove heat from said apparatus;
f. and a means to power said apparatus.

2. A method of collapsing computing, storage and networking into a tightly coupled, deeply vertically integrated systems consisting of:
a. means to compute information which includes a means to offer additional computing functions;
b. and means to store data in a non-volatile solid state storage medium where said means includes an ability to intelligently process data within the storage means;
c. and means to interconnect between the said means to compute information and said means to store data wherein said means to interconnect includes the ability to intelligently process one or more of the incoming request or outgoing responses such that neither the said means to compute information nor said means to store data need be involved in the intelligent processing of the one or more incoming requests or outgoing responses; said means to interconnect also offering the ability to communicate outside of the means to communicate information and means to store data wherein said means to interconnect can use its intelligent processing to effect intelligent communication between means to interconnect to provide scalable interconnect between various interrelated means to interconnect.

3. A system consisting of two or more interconnected apparatus wherein each apparatus has:
a. computing element having means to communicate to other elements within the apparatus; said computing element consisting of one or more computing functions built from one or more technologies including Central Processing Units (CPUs), Graphics Processing Units (GPUs), or Field Programmable Gate Arrays (FPGAs); said computing means further having augmented intelligence contained within or beside the computing means to effect additional work on information being processed by said computing means; said computing element having a means to intelligently communicate outside the element;
b. and a solid state storage element having means to communicate to other elements within the apparatus; said solid state storage element having a programmable hardware intelligence and programmable software intelligence to effect useful work directly within the solid state storage element; said solid state storage element being capable of the non-volatile storage of data; said solid state storage element having a means to intelligently communicate outside the element;
c. and a network element having means to communicate to other elements within the apparatus; said network element having a local hardware intelligence within the network element and augmented by additional software intelligence; said network element being capable of accepting requests and data from either outside the apparatus or from inside the apparatus and responding to said requests and data without the intervention of other elements in the apparatus; said network element having the means to communicate intelligently with the other elements both inside and between other apparatuses, including the ability to intelligently communicate outside the system formed by one or more interconnected apparatus;
d. and a means to interconnect one or more said computing elements, one or more said solid state storage elements, and one or more network element;
e. and a means to remove heat from said apparatus;
f. and a means to power said apparatus;
g. wherein said system utilizes the means of interconnection to effect intelligent and cooperative communication between said apparatuses

4. The apparatus of claim 1 wherein there the means to interconnect the said computing elements, said solid state storage elements, and said network elements consists of a set of interfaces that permit said elements to be removed from said means of interconnect and replaced with other types of elements, or other designs of the computing element, solid state storage element, or network element.

5. The apparatus of claim 1 wherein the network element includes multiple kinds of networks and multiple kinds of network topologies.

6. The apparatus of claim 1 which further includes a means to provide sufficient power when AC line power fails such that the apparatus can at least shut down in an orderly manner without the loss of information.

7. The method of claim 2 wherein the augmented intelligence available via the means to compute information, means to store data, and means to interconnect is used to allow for breaking up of information processing into each of the means to compute information, means to store data, and means to interconnect as appropriate to perform the overall function faster and with less communication of data between each means.

8. The method of claim 2 wherein the collapsed computing, storage and networking can be used to provide high performance computing like functionality

9. The method of claim 2 wherein the collapsed computing, storage and networking can utilize the means to interconnect to act as the sole means to serve information requests and distribute said information requests and their associated data and responses to one or more of the appropriate means to compute information or means to store data without utilizing either of the means to compute information or means to store data as part of that serving function.

10. The system of claim 3 further consisting of a sizable network of interconnected said apparatuses which together perform the function of a large computer; said computer being capable of directly mining data from one or more said apparatuses one or more solid state storage elements without the intervention of any other element; said data mining being capable of scaling to the limit of said system utilizing the one or more apparatuses one or more network means to provide the communication path necessary where said apparatuses are interconnected between each other using the external connections that each apparatus's network means provides.

11. The apparatus of claim 1 wherein the solid state storage element consists of one or more Field Programmable Gate Array (FPGAs) that directly couple one or more channels of NAND memory to said one or more FPGAs; one or more Central Processing Units (CPUs) having augmented intelligence that provide at least a means to directly process network communications protocols; said CPUs having a high speed solid state temporary storage means which may include one or more channels of DDR3 SDRAM; said FPGAs having a high speed solid state temporary storage means which may include one or more channels of DDR3 SDRAM; said FPGAs and said CPUs being operatively coupled with one ore more direct interfaces between said FPGA and said CPUs such that said CPUs and said FPGAs can communicate with each other; said one or more CPUs having means to communicate outside said solid state storage element to one or more of other solid state storage elements, compute elements or network elements; said one or more FPGFAs having means to communicate outside said solid state storage element to one or more of other solid state storage elements, compute elements or network elements.

12. The apparatus of claim 1 wherein the computing element consists of one or more instances of one or more classes of processing means wherein a processing means could be a Central Processing Unit, a Graphics Processing Unit, or a Field Programmable Gate Array made to act as some form of information processor; wherein said processing means includes augmented intelligence with at least a means to directly process network communications protocols and may include additional augmented intelligence to perform other higher level functions; said processing means each further having a high speed solid state temporary storage means which may include one or more channels of DDR3 SDRAM; said processing means further having means to directly communicate locally between each processing means contained within the computing element; said processing means each further having a means to communicate outside said computing element to one or more of other solid state storage elements, compute elements or network elements.

13. The apparatus of claim 1 wherein the network elements consists of one or more instances of appropriate switches to effect interswitch communication sufficient for the intended communication bandwidth of the network element's external agent wherein an external agent is one or more of a computing element, a solid state storage element, other network elements within the apparatus, other network elements outside the apparatus, or other agents external to the apparatus that are not part of the apparatus, e.g. the internet; said switches having augmented intelligence consisting of at least deep packet inspection and decision logic which permits the switching of ingress packets on a particular switch and routing an egress packet to a potentially different switch within the network element; said augmented intelligence being additionally augmented by a means to access at least one or more computing elements for processing beyond the capability of the network element; said network element each further having a means to communicate outside said network element to one or more of other solid state storage elements, compute elements, network elements or outside the apparatus.

14. The method of claim 2 wherein [symbol]
